(19) United States
(12) Patent Application Publication
(10) Pub. No.: US 2019/0132724 A1
(43) Pub. Date: May 2, 2019

(54) SYSTEMS FOR SIGNALING COMMUNICATION CHARACTERISTICS

(71) Applicant: QUALCOMM Incorporated, San Diego, CA (US)

(72) Inventors: Alfred ASTERJADHI, San Diego, CA (US); Abhishek Pramod PATIL, San Diego, CA (US); George CHERIAN, San Diego, CA (US); Bin TIAN, San Diego, CA (US)

(21) Appl. No.: 16/171,164

(22) Filed: Oct. 25, 2018

Related U.S. Application Data
(60) Provisional application No. 62/577,537, filed on Oct. 26, 2017.
(60) Provisional application No. 62/617,991, filed on Jan. 16, 2018.
(60) Provisional application No. 62/632,581, filed on Feb. 20, 2018.

(51) Int. Cl. H04W 8/00; H04W 72/04; H04L 29/08

(52) U.S. Cl. CPC H04W 8/005; H04L 69/324; H04W 72/04

(57) ABSTRACT

This disclosure generally relates to systems, devices, apparatuses, products, and methods for signaling communication characteristics between wireless devices. In one implementation, a first wireless communication device may determine that a trigger frame will allocate one or more resource units for communications by one or more stations unassociated with the first wireless communication device. The first wireless communication device adds an indication of a reference channel associated with the first wireless communication device or a basic service set (BSS) color indication to the trigger frame. The trigger frame is output for transmission to one or more other wireless communication devices. A receiving device may then identify the reference channel or the BSS color indication from the trigger frame and use this information for communication with the first wireless communication device.

### CROSS-REFERENCE TO RELATED APPLICATION(S)

This application claims the benefit of U.S. Provisional Application Ser. No. 62/632,581, entitled “SYSTEMS FOR SIGNALING COMMUNICATION CHARACTERISTICS” and filed on Feb. 20, 2018, which claims priority to U.S. Provisional Application Ser. No. 62/617,991, entitled “SYSTEMS FOR SIGNALING COMMUNICATION CHARACTERISTICS” and filed on Jan. 16, 2018, which claims priority to U.S. Provisional Application Ser. No. 62/577,537, entitled “SYSTEMS FOR SIGNALING COMMUNICATION CHARACTERISTICS” and filed on Oct. 26, 2017, all of which are expressly incorporated by reference herein in their entirety.

### BACKGROUND

### Field

This disclosure relates generally to wireless communications, and more specifically, to signaling communication characteristics of a communication device to other devices.

### Field

A wireless local area network (WLAN) may be formed by one or more access points (APs) that provide a shared wireless communication medium for use by one or more client devices, also referred to as stations (STAs). The basic building block of a WLAN conforming to the IEEE 802.11 family of standards is a Basic Service Set (BSS), which is managed by an AP that serves one or more STAs. Each BSS is identified by a service set identifier (SSID) that is advertised by the AP.

An AP periodically broadcasts beacon frames to enable any STAs within wireless range of the AP to establish and/or maintain a communication link with the WLAN. To identify an AP with which to associate, a STA may wait to receive a beacon frame from an AP or may be configured to perform active scans on the wireless channels of each of one or more frequency bands by sending one or more probe requests to elicit one or more probe responses from one or more APs. Using the information received in a beacon or a probe response, a STA may select an AP from multiple available APs within range of the STA. The STA may then associate with the selected AP and begin data communication through the AP after completion of the association process.

In some situations, an AP may send a communication that will be received by a STA that is not already associated with the AP. The communication itself may not provide all desired communication characteristics regarding the AP, and the STA may not otherwise have stored information regarding these communication characteristics of the AP. This missing information may be helpful for the STA to effectively formulate full responses back to the AP. Thus, an improved communication mechanism between STAs and APs may be desired that provides additional communication characteristics of the AP to STAs in these situations.

### SUMMARY

The systems, methods and devices of this disclosure each have several innovative aspects, no single one of which is solely responsible for the desirable attributes disclosed herein. This disclosure generally relates to systems, devices, apparatuses, products, and methods for providing communication characteristics between wireless devices.

In one implementation, a first wireless communication device may determine that a trigger frame will allocate one or more resource units for communications by one or more stations unassociated with the first wireless communication device. The first wireless communication device adds an indication of a reference channel associated with the first wireless communication device or a basic service set (BSS) color indication to the trigger frame. The trigger frame is output for transmission to one or more other wireless communication devices.

In another implementation, a second wireless communication device receives a trigger frame from a first wireless communication device. The second wireless communication device determines that the trigger frame allocates one or more resource units for communications by the second wireless communication device that is unassociated with the first wireless communication device. The second wireless communication device may determine a reference channel associated with the first wireless communication device or a basic service set (BSS) color indication from the trigger frame.

In yet another implementation, a first wireless communication device determines that a trigger frame will allocate one or more resource units for communications by one or more stations unassociated with the first wireless communication device. A second frame is selected that includes an indication of a reference channel associated with the first wireless communication device or a basic service set (BSS) color indication associated with the first wireless communication device. The trigger frame is aggregated with the second frame into an aggregated data unit that is output for transmission to one or more other wireless communication devices.

In still another implementation, an aggregated data unit from a first wireless communication device is received at a second wireless communication device. The second wireless communication device determines that the aggregated data unit includes a trigger frame that allocates one or more resource units for communications by the second wireless communication device that is unassociated with the first wireless communication device. The second wireless communication device identifies that a second frame in the aggregated data unit includes an indication of a reference channel associated with the first wireless communication device or a basic service set (BSS) color indication associated with the first wireless communication device. The indication of the reference channel or the BSS color indication from the second frame is associated with information from the trigger frame based on the inclusion of the second frame in the aggregated data unit with the trigger frame.

In a further implementation, a second wireless communication device receives a trigger frame from a first wireless communication device. The second wireless communication device determines that the trigger frame allocates one or more resource units for communications by the second wireless communication device that is unassociated with the first wireless communication device. A location of the second wireless communication device is determined. The second wireless communication device may identify a reference channel associated with the first wireless communication device based on the location of the second wireless communication device.

Details of one or more implementations of the subject matter described in this disclosure are set forth in the accompanying drawings and the description below. Other features, aspects, and advantages will become apparent from the description, the drawings and the claims.

### BRIEF DESCRIPTION OF THE DRAWINGS

The system may be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a diagram illustrating an example of a wireless local area network (WLAN) deployment.

FIG. 2 is a trigger frame formatted in accordance with various aspects of the present disclosure.

FIG. 3 is a diagram of a communication network including aspects of an AP configured for providing communication characteristics in accordance with various aspects of the present disclosure.

FIG. 4 is a diagram of a communication network including aspects of a STA configured for determining communication characteristics in accordance with various aspects of the present disclosure.

FIG. 5 is a flow diagram illustrating an example of a technique for adding a reference channel indication or BSS color indication to a trigger frame.

FIG. 6 is a user information subfield of a trigger frame.

FIG. 7 is a trigger dependent user information subfield of a trigger frame.

FIG. 8 is a flow diagram illustrating an example of a technique for identifying a reference channel indication or BSS color indication from a trigger frame.

FIG. 9 is a flow diagram illustrating an example of a technique for identifying a reference channel indication based on a location of a wireless communication device.

FIG. 10 is a flow diagram illustrating an example of a technique for aggregating a trigger frame with another frame to provide a reference channel indication or BSS color indication to a device that receives the aggregated frame.

FIG. 11 is a flow diagram illustrating an example of a technique for identifying a reference channel indication or BSS color indication for a trigger frame from a second frame aggregated with the trigger frame.

FIG. 12 is a flow diagram illustrating an example of a technique for signaling a reference channel indication by allocating one or more resource units within the reference channel.

FIG. 13 is a flow diagram illustrating an example of a technique for identifying a reference channel based on a location of one or more allocated resource units.

FIG. 14 is a frame diagram showing one example of a technique for signaling a reference channel indication by allocating a specific resource unit to be within the reference channel.

FIG. 15 is a frame diagram showing one example of duplicating a probe response across multiple sub-channels.

FIG. 16 is a frame diagram showing one example of locating a probe response in a same resource unit as used in an uplink probe request.

FIG. 17 is a conceptual data flow diagram illustrating the data flow between different means/components in an exemplary apparatus.

FIG. 18 is a diagram illustrating an example of a hardware implementation for an apparatus employing a processing system.

FIG. 19 is a conceptual data flow diagram illustrating the data flow between different means/components in an exemplary apparatus.

FIG. 20 is a diagram illustrating an example of a hardware implementation for an apparatus employing a processing system.

FIG. 21 is a conceptual data flow diagram illustrating the data flow between different means/components in an exemplary apparatus.

FIG. 22 is a diagram illustrating an example of a hardware implementation for an apparatus employing a processing system.

FIG. 23 is a conceptual data flow diagram illustrating the data flow between different means/components in an exemplary apparatus.

FIG. 24 is a diagram illustrating an example of a hardware implementation for an apparatus employing a processing system.

FIG. 25 is a conceptual data flow diagram illustrating the data flow between different means/components in an exemplary apparatus.

FIG. 26 is a diagram illustrating an example of a hardware implementation for an apparatus employing a processing system.

FIG. 27 is a conceptual data flow diagram illustrating the data flow between different means/components in an exemplary apparatus.

FIG. 28 is a diagram illustrating an example of a hardware implementation for an apparatus employing a processing system.

FIG. 29 is a conceptual data flow diagram illustrating the data flow between different means/components in an exemplary apparatus.

FIG. 30 is a diagram illustrating an example of a hardware implementation for an apparatus employing a processing system.

FIG. 31 is a flow diagram illustrating an example of a technique for indicating a BSS color indication in a header of an HE PPDU to a device for a random access communications.

FIG. 32 is a conceptual data flow diagram illustrating the data flow between different means/components in an exemplary apparatus.

FIG. 33 is a diagram illustrating an example of a hardware implementation for an apparatus employing a processing system.

FIG. 34 is a flow diagram illustrating an example of a technique for determine a BSS color indication based on a header of an HE PPDU of a trigger farme.

FIG. 35 is a conceptual data flow diagram illustrating the data flow between different means/components in an exemplary apparatus.

FIG. 36 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

The systems and techniques described in this detailed description provide various mechanisms for signaling additional communication characteristics of a first communication device to one or more other communication devices. These mechanisms may be helpful for enabling communications between an access point (AP) and a station (STA) that is not already associated with the AP. During the association process between a STA and an AP, many different types of information regarding the communication characteristics of the AP are transferred to the STA. The STA stores these communication characteristics and then uses them to communicate with the AP. However, when the AP sends a communication at least partially intended for one or more stations that are unassociated with the AP at the time of the communication (e.g., when the communication includes an indication of at least one resource allocated for communications by an unassociated STA), the unassociated STAs may lack one or more communication characteristics of the AP that the STA would otherwise use for future communication between the unassociated STA and the AP.

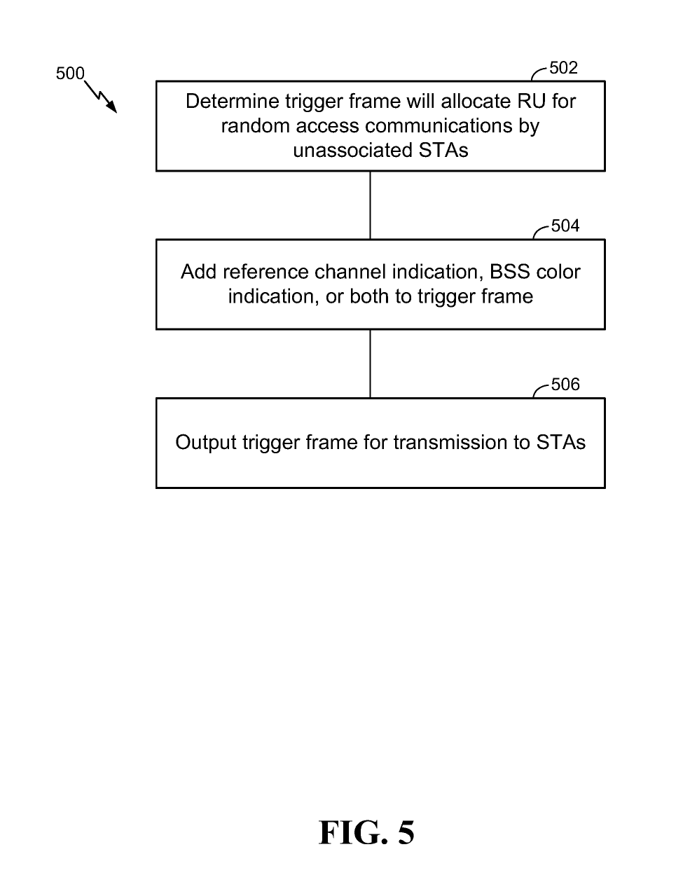

In some situations, a receiving STA may receive a frame from an AP and not know the AP's reference channel. For example, the received frame may be a trigger frame that allocates one or more resource units (RUs) for communications from an unassociated STA. The reference channel may indicate the AP's primary communication channel (e.g., the AP's primary 20 MHz bandwidth). The STA may use the knowledge of the AP's reference channel (e.g., once the reference channel is obtained according to one or more of the mechanisms described below in connection with FIGS. 5 and 8-11) to determine the location of specific allocated resource units (RUs) that are mapped relative to the location of the reference channel. An RU may be a sub-channel, within a larger channel bandwidth, that includes a subset of the channel's total available subcarriers. For example, in IEEE 802.11ax, an RU may be a group of 26, 52, 106, 242, 484, or 996 subcarriers (or tones). The RUs may be used by one or more STAs, such as in an orthogonal frequency-division multiple access (OFDMA) system. Once an allocated RU is located (based on knowledge of the location of the reference channel), the STA may use the RU to send a frame back to the AP. For example, the STA may send a probe request to the AP in the RU allocated for unassociated STAs. In some implementations, this probe request may be used initiate an association process between the STA and AP. Certain types of frames may not carry the AP's reference channel ordinarily, such as some versions of a trigger frame, and the STA may not have obtained the AP's reference channel through other ways (e.g., from a previous frame, such as a management frame, beacon frame, broadcast probe response, or another frame that includes this information). Thus, a need exists for a mechanism to provide the AP's reference channel to unassociated STAs when a trigger frame will allocate one or more RUs for unassociated stations.

In other situations, a receiving STA may receive a frame from an AP and not know the AP's basic service set (BSS) color information. The BSS color is an identifier of the BSS in which the frame is transmitted, which may be used by devices to differentiate frames belonging to one BSS from frames that belong to another BSS. Certain types of frames may not carry the AP's BSS color information ordinarily, such as some versions of a trigger frame, and the STA may not have obtained the AP's BSS color information through other ways (such as when a frame is sent in a legacy format (e.g., a format prior to IEEE 802.11ax) or when the STA has not acquired the information from a previous communication). When the frame received by the STA is a trigger frame, the STA may include the BSS color identifier in a trigger-based response frame back to the AP (e.g., once the BSS color identifier is obtained according to one or more of the mechanisms described below in connection with FIGS. 5, 8, and 10-11). Thus, a need exists for a mechanism to provide the AP's BSS color indication to unassociated STAs.

In these situations, the receiving STA may not have certain information regarding the communication characteristics of the AP that could be helpful for the STA to effectively communicate with the AP. As will be discussed in more detail below, the systems described herein provide mechanisms for the AP to provide additional communication characteristics (such as its reference channel and/or its BSS color indicator) to receiving STAs that may not otherwise have this information.

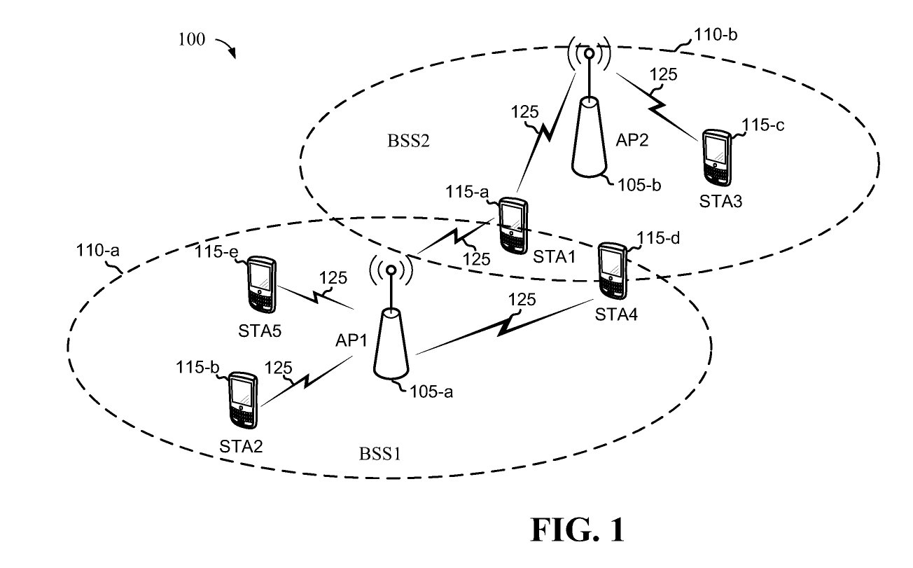

FIG. 1 is a wireless communication system 100 illustrating an example of a wireless local area network (WLAN) deployment in connection with various techniques described herein for a first device (e.g., an AP) to provide additional communication characteristics regarding its operation to other devices (e.g., STAs.) The WLAN deployment may include one or more access points (APs) and one or more wireless stations (STAs) associated with a respective AP. In this example, there are two APs deployed for illustrative purposes: AP1 105-a in basic service set 1 (BSS1) and AP2 105-b in BSS2. BSS1 and BSS2 may be identified by different BSS color indicators in communications to allow receiving devices to differentiate the source BSS of a communication according to which BSS color indicator is included in the communication. AP1 105-a is shown having multiple associated STAs (STA1 115-a, STA2 115-b, STA4 115-d, and STA5 115-e) and coverage area 110-a, while AP2 105-b is shown having multiple associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein are at least partially based on the example WLAN deployment of FIG. 1 but need not be so limited.

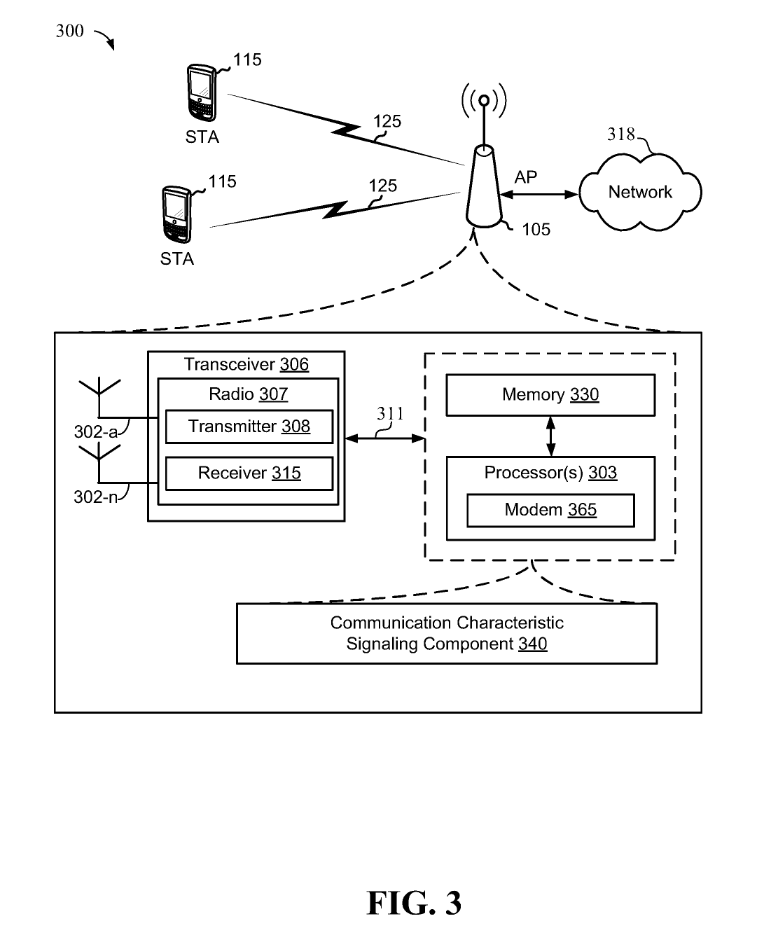

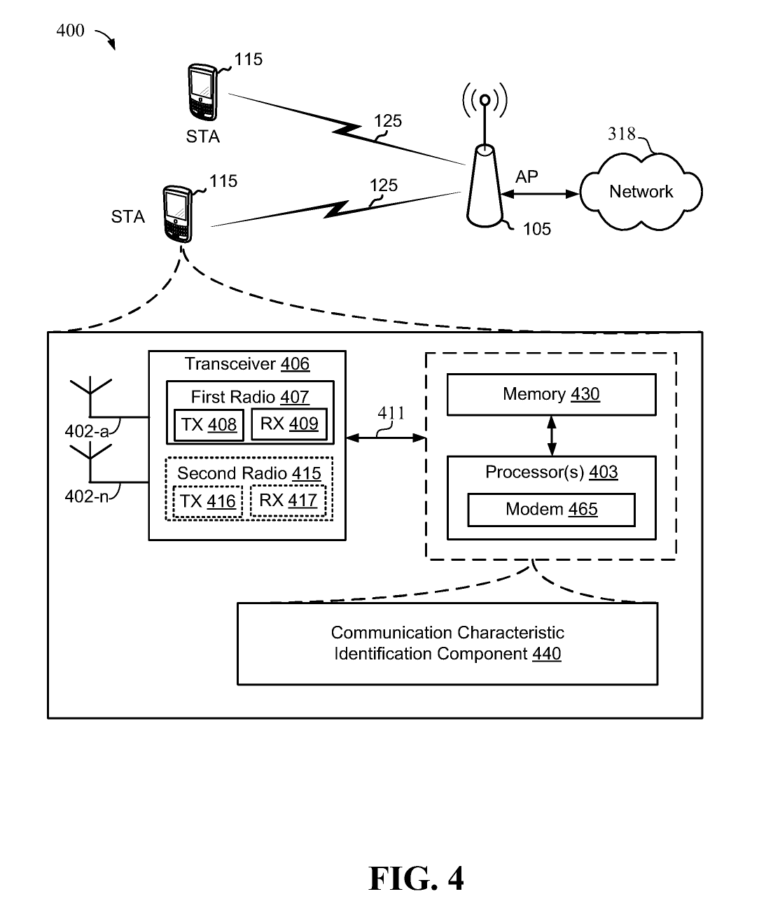

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The AP may also be a STA, such as a STA operating in an AP role. The STAs (e.g., STA1 115-a, STA2 115-b, STA3 115-c, STA4 115-d, and STA5 115-e) shown in FIG. 1, which may be fixed, non-fixed, or mobile terminals, utilize the backhaul services of their respective AP to connect to a network (see, e.g., network 318 in FIGS. 3 and 4), such as the Internet. Examples of a STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. A STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, a small cell, or any other suitable terminology. The various concepts described throughout this disclosure are intended to apply to all suitable wireless apparatus regardless of their specific nomenclature.

Each of STA1 115-a, STA2 115-b, STA3 115-c, STA4 115-d, and STA5 115-e may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications links 125. The APs can send frames to their respective STAs and receive frames from their respective STAs to communicate data and/or control information (e.g., signaling).

Each of AP1 105-a and AP2 105-b can establish a communications link 125 with a STA that is within the coverage area of the AP. Communications links 125 can comprise communications channels that can enable both uplink and downlink communications. When connecting to an AP, a STA can first authenticate itself with the AP and then associate itself with the AP. Once associated, a communications link 125 can be established between the AP and the STA such that the AP and the associated STA can exchange frames or messages through a direct communications channel.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN, and other technologies used in wide area networks (WANs), cellular networks, WLANs, personal area networks (PAN)s, or other suitable networks now known or later developed.

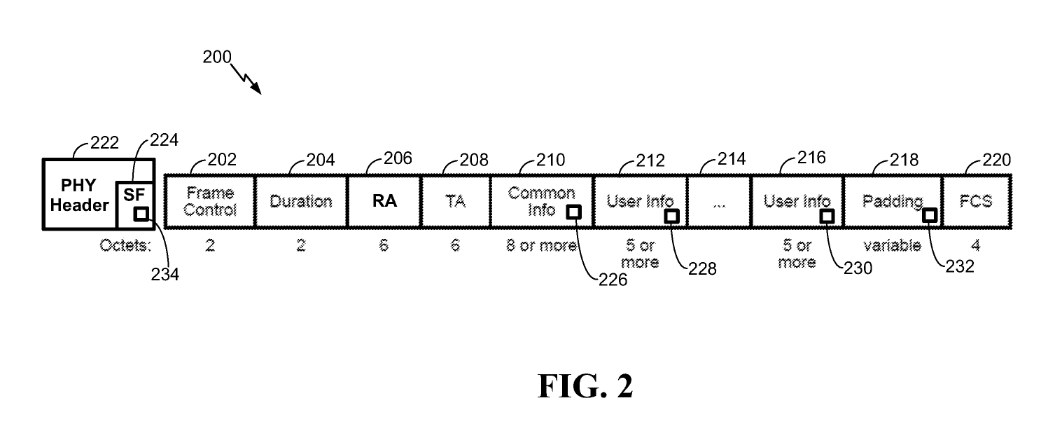

FIG. 2 illustrates an example of a trigger frame 200. An AP may send a trigger frame 200 to provide a transmission schedule to STAs. For example, the trigger frame 200 may specify which STAs can transmit during certain times and which subsets of orthogonal frequency-division multiple access (OFDMA) sub-carriers they will use. The trigger frame 200 solicits and allocates resources for uplink (UL) transmissions (including multi-user (MU) transmissions) scheduled after the Physical Layer Convergence Procedure (PLCP) protocol data unit (PPDU) that carries the trigger frame 200. The trigger frame 200 carries information used by the responding STA to send a trigger-based (TB) PPDU back to the AP. In one implementation, the trigger frame 200 may include a frame control field 202, a duration field 204, a recipient address (RA) field 206, a transmitter address (TA) field 208, a common information field 210, one or more user information fields 212, 214, and 216 (where field 214 represents zero or more additional user information fields), padding 218, and a frame check sequence (FCS) field 220.

The transmission that includes the trigger frame 200 may also include a physical (PHY) layer header 222 that is sent before the frame control filed 202 of the trigger frame 200. The PHY layer header 222 includes several different fields, including a scrambler field 224.

As will be discussed in more detail below in connection with FIGS. 5-8, the systems described herein may use one or more portions of the trigger frame 200, or its PHY header 222, to signal communication characteristics (e.g., communication parameters, etc.) to other devices. Specifically, the trigger frame 200 may be designed to include an indication of a reference channel associated with the device transmitting the trigger frame 200 and/or a BSS color indication. In some implementations, the trigger frame 200 may include one or more of these parameters in the common information field 210 at subfield 226, the user information field 212 at subfield 228, the user information field 216 at subfield 230, the padding field 218 at subfield 232, and/or the scrambler field 224 at location 234. A receiving STA may then be configured to analyze one or more of these subfields 226, 228, 230, 232, or 234 to determine the reference channel indication and/or the BSS color indication for the AP that sent the trigger frame 200.

FIG. 3 illustrates an example wireless communication system 300 that includes multiple STAs 115 in wireless communication with at least one AP 105 connected to network 318. The STAs 115 may communicate with network 318 via AP 105. In an example, STAs 115 may transmit and/or receive wireless communication to and/or from AP 105 via one or more communication links 125. Such wireless communications may include, but are not limited to, data, audio and/or video information. In some instances, such wireless communications may include control or similar information. An AP, such as AP 105, may be configured to perform the communication characteristic signaling techniques described herein for providing reference channel indicators and/or BSS color indicators to other communication devices.

In accordance with the present disclosure, AP 105 may include a memory 330, one or more processors 303 and a transceiver 306. The memory 330, the one or more processors 303 and the transceiver 306 may communicate internally via a bus 311. In some examples, the memory 330 and the one or more processors 303 may be part of the same hardware component (e.g., may be part of a same board, module, or integrated circuit). Alternatively, the memory 330 and the one or more processors 303 may be separate components that may act in conjunction with one another. The bus 311 may be a communication system that transfers data between multiple components and subcomponents of the AP 105. In some examples, the one or more processors 303 may include any one or combination of modem processor, baseband processor, digital signal processor, and/or transmit processor. The one or more processors 303 may include a modem 365. The AP 105 includes a communication characteristic signaling component 340 for carrying out one or more methods or procedures described herein in connection with an AP. The communication characteristic signaling component 340 may comprise hardware, firmware, and/or software and may be configured to execute code or perform instructions stored in a memory (e.g., a computer-readable storage medium). For example, the communication characteristic signaling component 340 may be implemented by the processor 303 executing instructions stored on memory 330.

In some examples, the memory 330 may be configured for storing data that is used in connection with local applications, and/or in connection with the communication characteristic signaling component 340 and/or one or more of any subcomponents being executed by the one or more processors 303. Memory 330 can include any type of computer-readable medium usable by a computer or processor 303, such as random access memory (RAM), read only memory (ROM), tapes, magnetic discs, optical discs, volatile memory, non-volatile memory, and any combination thereof. In an aspect, for example, memory 330 may be a computer-readable storage medium (e.g., a non-transitory medium) that stores computer-executable code. The computer-executable code may define one or more operations or functions of the communication characteristic signaling component 340 and/or one or more of any subcomponents, and/or data associated therewith. The computer-executable code may define these one or more operations or functions when AP 105 is using processor 303 to execute the communication characteristic signaling component 340 and/or one or more of any subcomponents. In some examples, the AP 105 may further include the transceiver 306 for transmitting and/or receiving one or more data and control signals (e.g., messages) to/from a STA. For example, the AP 105 may transmit trigger frames, probe responses, broadcast probe responses, beacons, Fast Initial Link Setup (FILS) discovery frames, or other data or control frames. In certain implementations, the AP 105 may send a FILS discovery frame at predetermined intervals (e.g., 1 ms, 2 ms, 5 ms, 10 ms, 20 ms, 50 ms, etc.) in order to assist an unassociated STA determine the BSS configuration (e.g., channel of the AP 105). The AP 105 may determine whether to send the FILS discovery frame by itself (i.e., single user (SU) transmission) or as part of a downlink multi-user PPDU, e.g., based at least in part on channel overhead, the amount of traffic on the medium, the rate of data throughput, and/or if the AP 105. In certain other implementations, the AP 105 may send a broadcast probe response at predetermined intervals (e.g., 1 ms, 2 ms, 5 ms, 10 ms, 20 ms, 50 ms, etc.) or as a response to one or more Probe Request frame in order to assist an unassociated STA determine the BSS configuration (e.g., channel of the AP 105. The AP 105 may determine whether to send the broadcast probe response by itself or as part of a downlink multi-user PPDU, e.g., based at least in part on channel overhead, the amount of traffic on the medium, the rate of data throughput, and/or if the AP 105.

In certain other implementations, the AP 105 may aggregate the FILS discovery frame or broadcast probe response in a broadcast resource unit (RU) of a high-efficiency (HE) PPDU (e.g., an HE downlink (DL) multiuser (MU) PPDU). An HE PPDU may include multiple RUs that may be directed/dedicated RUs for STAs associated with the AP 105. In certain aspects, the AP may include one broadcast RU that may carry either a FILS discovery frame or a broadcast Probe Response. A broadcast RU may carry either a FILS discovery frame or a broadcast probe response when the medium is busy and the AP 105 has downlink traffic for one or more associated STAs. In such an instance, it may be efficient to include a broadcast RU to carry the FILS discovery frame or a broadcast probe response since the AP 105 to contend and access the medium anyways. An identifier (ID) of the broadcast RU may be a special ID or a same/similar ID as the one currently assigned to indicate a broadcast probe response for a STA that is unassociated with the AP 105. The STAs may derive the configuration of the BSS color indication of the AP 105 upon receiving the FILS discovery frame or the broadcast, and use the BSS color indication to determine whether to communicate with the AP 105. For example, the STAs may determine the configuration of the BSS color indication based on the HE signal (SIG) field in the physical layer (PHY) header of the HE PPDU. Since the PHY headers include HE SIG fields which carry the BSS color information, an AP 105 can provide BSS color information to an interest STA by transmitting the PPDU in HE format. By receiving a trigger frame, FILS Discovery frame, or Probe Response frame in HE PPDU format, an unassociated STA would be able to determine information, such as the BSS color, primary channel, operating bandwidth, etc., associated with the AP 105. In certain configurations, upon determining to communicate with the AP 105, the STA may use the BSS color indication to determine a primary channel for communication with the AP, RU allocation index in the trigger frame of the AP 105 and the BSS color of the AP's BSS color indication. In certain implementations, the AP 105 may send a broadcast probe response or a FILS discovery frame to one or more STAs with or without aggregation. The transceiver 306 may comprise hardware, firmware, and/or software and may be configured to execute code or perform instructions stored in a memory (e.g., a computer-readable storage medium). The transceiver 306 may include one or more radios, including a radio 307 comprising a transmitter 308 and a receiver 315. The radio 307 may utilize one or more antennas 302 (e.g., antennas 302-a, . . . , 302-n) for transmitting signals to and receiving signals from a plurality of STAs. The receiver 315 may include one or more components that form a receiving chain and the transmitter 308 may include one or more components that form a transmitting chain.

The communication characteristic signaling component 340 may be configured to perform, alone or in combination with other components of the AP 105, at least any AP-side functions described in connection with the flow diagrams of FIGS. 5 and 8-11.

FIG. 4 illustrates an example wireless communication system 400 similar to the wireless communication system 300 in FIG. 3. One or more of the STAs 115 may be configured to participate in the communication characteristic signaling process described herein.

In accordance with the present disclosure, a STA 115 may include a memory 430, one or more processors 403 and a transceiver 406. The memory 430, the one or more processors 403 and the transceiver 406 may communicate internally via a bus 411. In some examples, the memory 430 and the one or more processors 403 may be part of the same hardware component (e.g., may be part of a same board, module, or integrated circuit). Alternatively, the memory 430 and the one or more processors 403 may be separate components that may act in conjunction with one another. The bus 411 may be a communication system that transfers data between multiple components and subcomponents of the STA 115. In some examples, the one or more processors 403 may include any one or combination of modem processor, baseband processor, digital signal processor, and/or transmit processor. The one or more processors 403 may include a modem 465. The STA 115 includes a communication characteristic identification component 440 for carrying out one or more methods or procedures described herein in connection with a STA. The communication characteristic identification component 440 may comprise hardware, firmware, and/or software and may be configured to execute code or perform instructions stored in a memory (e.g., a computer-readable storage medium). For example, the communication characteristic identification component 440 may be implemented by the processor 403 executing instructions stored on memory 430.

In some examples, the memory 430 may be configured for storing data that is used in connection with local applications, and/or in connection with the communication characteristic identification component 440 and/or one or more of any subcomponents being executed by the one or more processors 403. Memory 430 can include any type of computer-readable medium usable by a computer or processor 403, such as random access memory (RAM), read only memory (ROM), tapes, magnetic discs, optical discs, volatile memory, non-volatile memory, and any combination thereof. In an aspect, for example, memory 430 may be a computer-readable storage medium (e.g., a non-transitory medium) that stores computer-executable code. The computer-executable code may define one or more operations or functions of the communication characteristic identification component 440 and/or one or more of any subcomponents, and/or data associated therewith. The computer-executable code may define these one or more operations or functions when STA 115 is using processor 403 to execute the communication characteristic identification component 440 and/or one or more of any subcomponents. In some examples, the STA 115 may further include the transceiver 406 for transmitting and/or receiving one or more data and control signals (e.g., messages) to/from a STA. The transceiver 406 may comprise hardware, firmware, and/or software and may be configured to execute code or perform instructions stored in a memory (e.g., a computer-readable storage medium). The transceiver 406 may include multiple radios that enable the STA 115 to operate as a multi-mode device or client. In this example, the transceiver 406 may include a first radio 407 having a transmitter (TX) 408 and a receiver (RX) 409, and a second radio 415 having a TX 416 and a RX 417. The first radio 407 may be a WLAN or Wi-Fi radio and the second radio 415 may be a non-WLAN system or non-Wi-Fi system radio (e.g., an LAA radio, an LTE-U radio).

Each of the first radio 407 and the second radio 415 may utilize one or more antennas 402 (e.g., antennas 402-a, . . . , 402-n) for transmitting signals to and receiving signals from an AP. The receivers 409 and 417 may include one or more components that form a receiving chain, and the transmitters 408 and 416 may include one or more components that form a transmitting chain.

The communication characteristic identification component 440 may be configured to perform, alone or in combination with other components of the STA 115, at least the STA-side functions described in connection with the flow diagrams of FIGS. 5, 8-11, 12, and 13.

Referring to FIGS. 5, 8-11, 12, and 13, examples of one or more operations related to the AP 105 (FIG. 3) and the STA 115 (FIG. 4) are described with reference to one or more methods and one or more components. Although the operations described below are presented in a particular order and/or as being performed by an example component, it should be understood that the ordering of the actions and the components performing the actions may be varied, depending on the implementation. Moreover, it should be understood that the following actions may be performed by a specially-programmed processor, a processor executing specially-programmed software or computer-readable media, or by any other combination of a hardware component and/or a software component specially configured for performing the described actions or components. For example, the various steps shown in FIGS. 5 and 8-11 may be performed by a processor (e.g., processor 303 for AP-side functions or processor 403 for STA-side functions) coupled with memory (e.g., memory 330 for AP-side functions or memory 430 for STA-side functions) that stores instructions executable by the processor to perform the described action. Other STA or AP sub-components may also be involved in each step, such as transceivers and antennas for any receive and/or transmit steps. Also, any steps described as being performed by an AP may alternatively be performed by a STA, such as a STA operating in an AP mode or in a STA-to-STA direct communication mode. Similarly, any steps described as being performed by a STA may alternatively be performed by an AP, such as an AP discovering communication characteristics of other APs or STAs.

FIG. 5 is a flow diagram illustrating an example of a process 500 for adding a reference channel indication or BSS color indication to a trigger frame, in accordance with various aspects of the present disclosure. In process 500, a wireless communication device, such as an AP (for triggering a STA to generate a trigger-based response) or a STA (for triggering another STA to generate a trigger-based response) generates a trigger frame. Note that for the remainder of the description of this flow diagram, an AP (e.g., AP 105 of FIG. 3) will be described as the wireless communication device sending the trigger frame, although the trigger frame may be generated by a STA (e.g., STA 115 of FIG. 4) in other implementations.

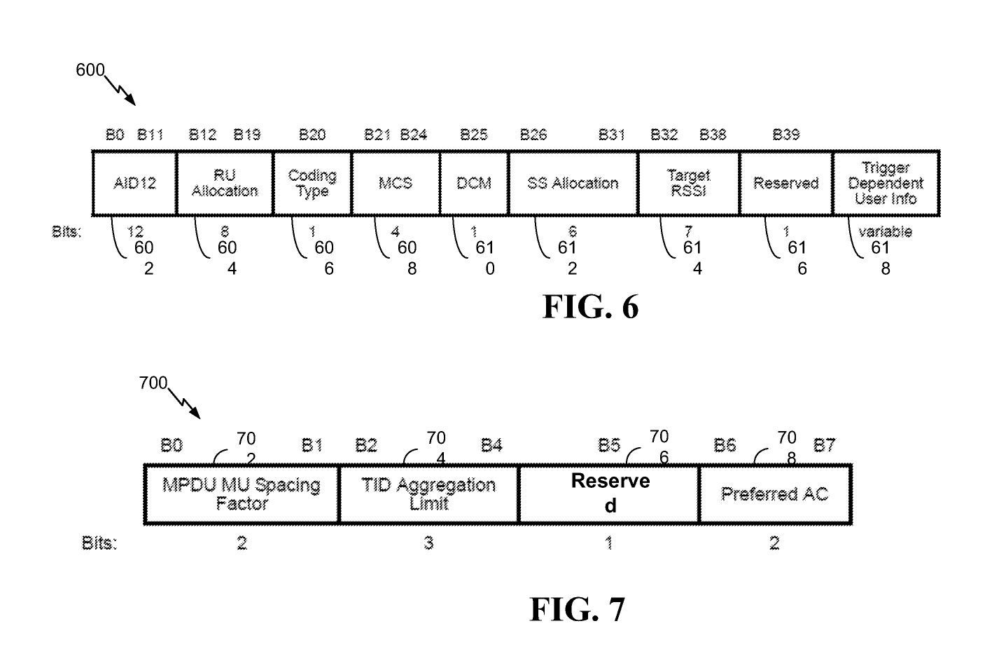

At block 502, the AP may determine that it will be sending a trigger frame (e.g., the trigger frame 200 of FIG. 2) that allocates one or more RUs for random access communications by one or more STAs that are currently unassociated with the AP. Random access communications in one implementation differ from directed communications in that any STA within a designated category (e.g., all associated STAs or all unassociated STAs) may access an allocated RU in random access communication mode as opposed to only a specific STA directed by the AP to use the RU in directed communication mode. When an RU is allocated for random access communications by unassociated STAs, any unassociated STA may contend for the allocated RU. The AP may customize the fields of the trigger frame to indicate that it allocates one or more RUs for random access communications by one or more STAs that are currently unassociated with the AP. In one implementation, the AP may signal the random access RU allocation in a user information field of the trigger frame (e.g., user information field 212 of trigger frame 200 of FIG. 2). FIG. 6 shows one example of a user information field 600, such as one of user information fields 212, 214, or 216 (see FIG. 2). The user information field 600 includes an AID12 subfield 602, an RU allocation subfield 604, a coding type subfield 606, a modulation coding scheme (MCS) subfield 608, a dual carrier modulation (DCM) subfield 610, a spatial stream (SS) allocation subfield 612, a target received signal strength indicator (RSSI) subfield 614, a reserved subfield 616, and a trigger dependent user information subfield 618.

In one implementation, the AP uses the AID subfield 602 to signal that the trigger frame includes one or more RUs allocated for random access communications by one or more STAs that are currently unassociated with the AP. The AID12 subfield 602 carries the 12 least significant bits of the association identification (AID) of the STA for which the user information field 600 is intended. When the AP sets the AID subfield 602 to a value of 0, the AP is indicating that the user information field 600 is allocated for random access communications by STAs that are already associated with the AP. Alternatively, when the AP sets the AID subfield 602 to a value of 2045, the AP is indicating that the user information field 600 is allocated for random access communications by STAs that are unassociated with the AP. Although the value of AID12=2045 is used herein to indicate a situation where at least one resource unit is allocated for random access communications by STAs that are unassociated with the AP, values other than 2045 may instead be designated to indicate this situation in other implementations (such as if the IEEE 802.11ax standard, or later standards, changes which value signals this type of allocation).

When the AID12 subfield 602 is set to 2045, the RU allocation subfield 604 indicates the RU assignment that is allocated for random access communications by any STAs that are unassociated with the AP. A STA that receives this indication may send a trigger-based PPDU in response to the trigger frame on the allocated RU (e.g., it may use the subcarriers of the allocated RU to transmit its response frame). However, because the STA is not yet associated with the AP, the STA may not know the reference channel that is used by the AP. An unassociated STA may also not know the BSS color indicator that is associated with the AP (e.g., such as when the trigger frame is sent by an AP within a PPDU formatted according to a legacy format instead of an IEEE 802.11ax or later formatted PPDU). A STA's knowledge of the AP's reference channel may be needed for the STA to properly determine the location of the allocated RU for random access communications because the location of the RU may be signaled and mapped relative to a location of the AP's reference channel. Furthermore, a STA's knowledge of the BSS color indicator may be needed for the STA to properly respond to the trigger message because the STA may include the AP's BSS color indicator in the trigger-based response PPDU sent back to the AP. Thus, in some implementations, the AP may format the outgoing trigger frame to provide the reference channel indicator, the BSS color indicator, or both in the trigger frame to signal these communication characteristics to receiving STAs that may not already have received or stored this type of information about the AP.

At block 504 of FIG. 5, the AP includes a reference channel indication, a BSS color indication, or both within the trigger frame (e.g., the trigger frame 200 of FIG. 2). The AP may use one or more different ways to signal this information to receiving STAs.

In a first implementation, the AP may signal the reference channel used by the AP in a common information field of the trigger frame. Specifically, the AP may include the reference channel indicator in subfield 226 of the common information subfield 210 of the trigger frame 200 of FIG. 2. The subfield 226 may be a new field added to the common information subfield 210 of the trigger frame 200 specifically to signal the reference channel of the AP. Alternatively, the AP may create the subfield 226 by repurposing all or a portion of an existing sub-field of the common information field 210 to serve a different purpose and carry the reference channel indicator only when the trigger frame includes one or more RUs allocated for random access communications by one or more unassociated STAs. A receiving STA would know to interpret this portion of the common information field 226 as the reference channel indicator when the trigger frame 200 includes an AID12 subfield that equals 2045 (which indicates an RU is allocated for RA operation by an unassociated STA).

In a second implementation, the AP may signal the reference channel used by the AP in a padding field of the trigger frame. Specifically, the AP may include the reference channel indicator in subfield 232 of the padding subfield 218 of the trigger frame 200 of FIG. 2. The padding subfield 218 extends the length of the frame to give the recipient STAs more time to prepare a response. The padding subfield 218, if present, may be variable in size and may be an integer number of two or more octets. The padding field 218 may ordinarily be set to all 1s during standard trigger frame operations. However, when the trigger frame includes an RU allocated for random access operations by an unassociated STA, a portion of the padding field 218 may be repurposed to signal the reference channel of the AP. The start of the padding field 218 may be identified by the value 4095 (or any other value designated to indicate the start of the padding field) that appears in the position of an AID12 subfield of a user information field that would otherwise be present at that location if the padding was not starting. The AID12 value 4095 (or alternatively whichever other value has been designated to indicate the start of the padding field) is reserved as the special value to indicate the start of the padding. Thus, the first twelve bits of the padding field 218 may be reserved as all 1s, and then any following bits in the padding field 218 after the first 12 bits could be used to signal the reference channel of the AP. The AP may, in some implementations, use eight bits to represent the reference channel indicator. Thus, if the padding field 218 is at least 20 bits long, then the padding field 218 could be used to indicate the reference channel. A receiving STA would know to interpret bits 13-20 (or any other agreed upon set of available padding bits) as the reference channel when the trigger frame includes an AID12 that equals 2045 (which indicates an RU is allocated for RA operation by an unassociated STA).

In a third implementation, the AP may signal the reference channel used by the AP in the user information field of the trigger frame. Specifically, the AP may include the reference channel indicator in subfield 228 of the user information subfield 212 (or similarly in subfield 230 or the user information subfield 216) of the trigger frame 200 of FIG. 2. The subfield 228 may be a new field added to the user information subfield 212 of the trigger frame 200 specifically to signal the reference channel of the AP. Alternatively, the AP may create the subfield 228 by repurposing all or a portion of an existing sub-field of the user information field 212 to serve a different purpose and carry the reference channel indicator only when the trigger frame includes one or more RUs allocated for random access communications by one or more unassociated STAs. A receiving STA would know to interpret this portion of the user information field 212 as the reference channel when the trigger frame includes an AID12 field with a value that equals 2045 (which indicates an RU is allocated for RA operation by an unassociated STA).

As one example of repurposing an existing portion of the user information field 212 to carry the reference channel indicator, an AP may repurpose the trigger dependent user information subfield 618 of the user information field 600 of FIG. 6. FIG. 6 shows a user information field 600 as a specific example of the user information field 212 of the trigger frame of FIG. 2 that includes a trigger dependent user information subfield 618. In some implementations, only a basic variant version of a trigger frame is permitted for use to allow random access operations by unassociated STAs. The basic variant version of the trigger frame includes the trigger dependent user information subfield 618. FIG. 7 shows a trigger dependent user information subfield 700 (as a specific example of the trigger dependent user information subfield 618 of FIG. 6). The trigger dependent user information subfield 700 includes a MAC protocol data unit (MPDU) multi-user (MU) spacing factor subfield 702, a traffic identifier (TID) aggregation limit subfield 704, a reserved subfield 706, and a preferred access class (AC) subfield 708. When the AP is allocating RUs for random access operations by unassociated STAs, the AP can repurpose all or a portion of the subfields of the trigger dependent user information subfield 700 because at least some of the subfields do not apply in this situation because unassociated STAs are expected to only send management frames to the AP in a trigger-based PPDU via random access operations. In one implementation, the AP repurposes all eight bits of the trigger dependent user information subfield 700 to carry the reference channel indication. In this situation, to accommodate the loss of the TID aggregation subfield data, the AP and any STAs may agree on a rule that in these situations all frames sent by unassociated STAs via random access are to be acknowledged by the AP. A receiving STA would know to interpret the trigger dependent user information subfield 700 as the reference channel indicator when the trigger frame includes an AID12 field with a value that equals 2045 (which indicates an RU allocated for RA operation by an unassociated STA). If the AID12 field is populated with a value that equals a different value, then the traditional meaning of the trigger dependent user information subfield 700 may control.

As another example of repurposing an existing portion of the user information field 212 to carry the reference channel indicator, an AP may repurpose the RU allocation subfield 604 of the user information field 600 of FIG. 6. In this example, the AP may use the eight bits of the RU allocation subfield 604 to signal the reference channel used by the AP. In this situation, to accommodate the loss of the traditional RU allocation subfield data, the AP and any STAs may establish a rule that in these situations the RU size will be fixed as a 26 tone RU. Also, in this situation, the SS allocation field 612 may be overloaded with data to indicate the number of contiguous RUs allocated for random access communications by unassociated STAs. A receiving STA would know to interpret the RU allocation subfield 604 as the reference channel indicator and the SS allocation subfield 612 as the number of RUs allocated when the trigger frame includes an AID12 field with a value that equals 2045 (which indicates an RU is allocated for RA operation by an unassociated STA). If the AID12 field is populated with a value that equals a different value, then the traditional meaning of the RU allocation subfield 604 and SS allocation subfield 612 may control.

In a fourth implementation, the AP may signal the reference channel used by the AP in the PHY header that carries the trigger frame. Specifically, the AP may include the reference channel indicator in subfield 234 within the scrambler field 224 of the PHY header 222 of FIG. 2. The subfield 234 may be a new field added to the scrambler field 224 specifically to signal the reference channel of the AP. Alternatively, the AP may create the subfield 234 by repurposing all or a portion of an existing sub-field of the scrambler field 224 to serve a different purpose and carry the reference channel indicator only when the trigger frame includes one or more RUs allocated for random access communications by one or more unassociated STAs. The AP may repurpose the scrambler field 224 to carry this information in this situation (e.g., supplementing existing trigger frame information) because scrambler fields are used when a frame is retransmitted and trigger frames are not retransmitted. A receiving STA would know to interpret this portion of the scrambler field 224 as the reference channel when the trigger frame includes an AID12 field with a value that equals 2045 (which indicates an RU is allocated for RA operation by an unassociated STA).

The various options and examples described above in connection with adding an indicator of a communication characteristic at block 504 were described with a focus on adding an indicator of the reference channel of the AP. However, each of the same options and examples described above could alternatively be used to signal the BSS color indicator associated with the AP. For example, the AP could signal the BSS color indicator by adding the BSS color indicator to the subfield 226 of the common information subfield 210, the subfield 232 of the padding subfield 218, the subfield 228 of the user information subfield 212 (or similarly the subfield 230 or the user information subfield 216), or the subfield 234 within the scrambler field 224. Additionally, the various options and examples described above in connection with adding an indicator of the reference channel of the AP may alternatively be used to signal any other attribute, property, or characteristic of the AP or the BSS which may otherwise be unknown to unassociated STAs before beginning communication with the AP. These obscure attributes are not generally known to unassociated STAs unless they receive the information in some type of management frame from the AP. The AP may use these areas of the trigger frame to signal any other characteristics or information regarding the BSS or AP other than the BSS color and the AP's reference channel (or in addition to the BSS color and/or the AP's reference channel).

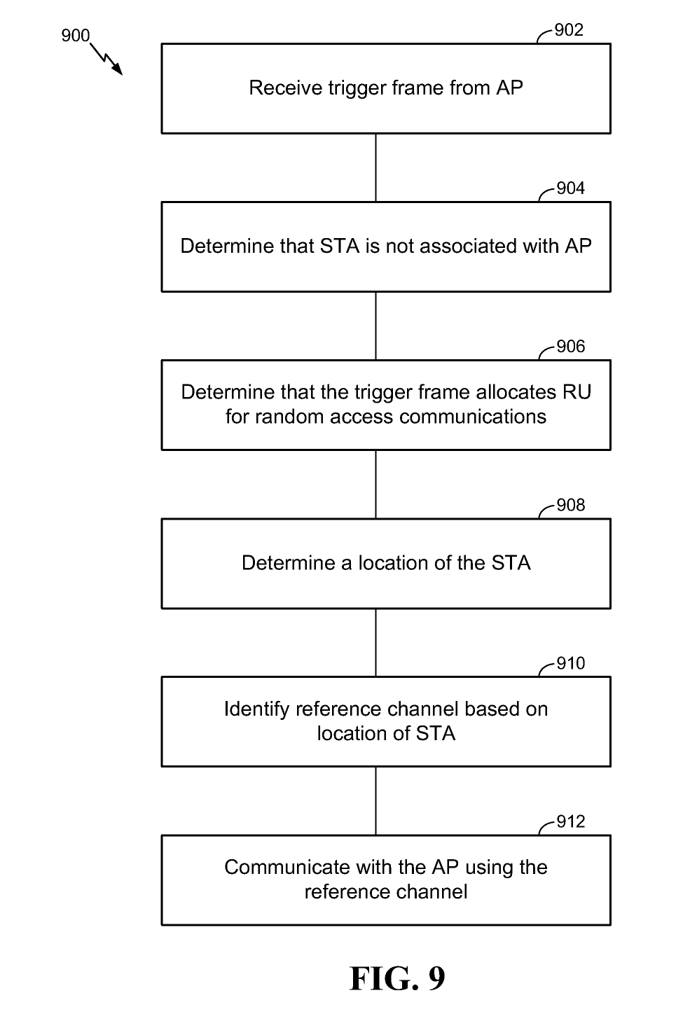

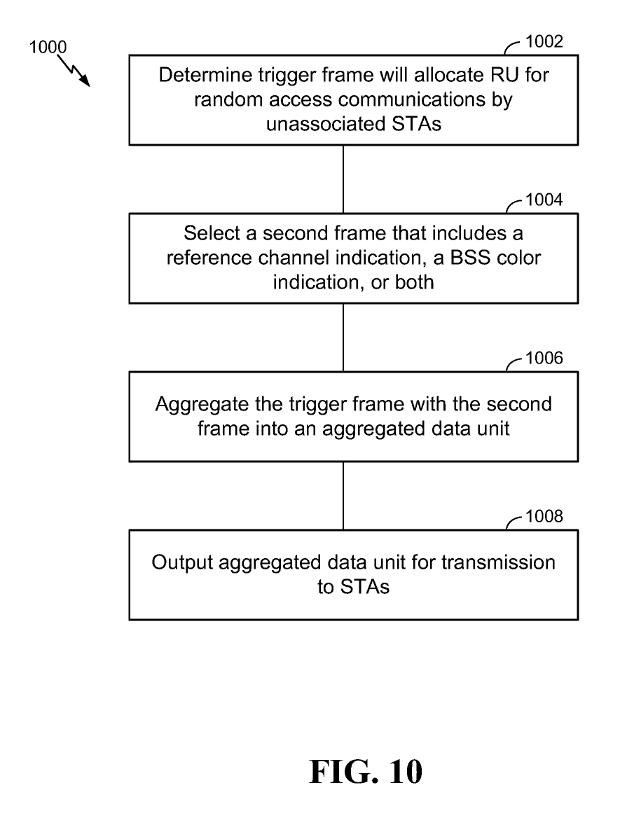

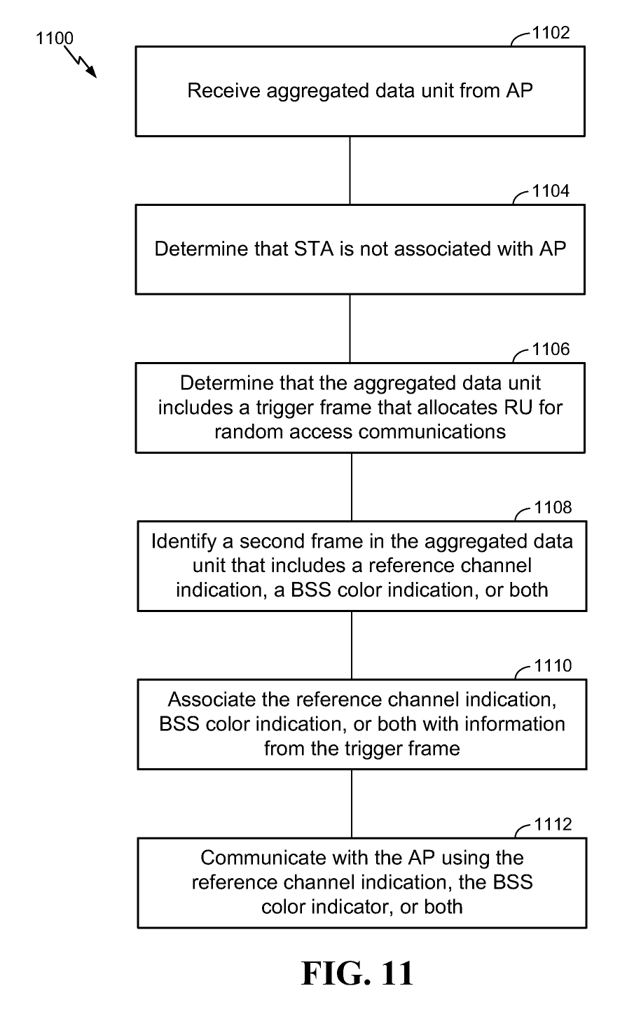

In some implementations, the trigger frame itself may signal the reference channel of the AP and not the BSS color indicator of the AP. In these implementations, the BSS color indicator may be conveyed in a different manner (e.g., by aggregating the trigger frame with another frame that carries BSS color (see FIGS. 10-11) or by transmitting the trigger frame in a PPDU formatted according to IEEE 802.11ax or future formats). In other implementations, the trigger frame may signal the BSS color indicator of the AP and not the reference channel of the AP. In these implementations, the reference channel indicator may be conveyed in a different manner (e.g., by aggregating the trigger frame with another frame that carries the reference channel indicator (see FIGS. 10-11) or by using a location based determination (see FIG. 9)). In these implementations, only one of the subfields 226, 228, 230, 232, or 234 may be needed to carry the desired information. Alternatively, when both the reference channel of the AP and the BSS color indicator are signaled by the AP in the trigger frame, then two or more of the subfields 226, 228, 230, 232, or 234 may be used. When one of the subfields 226, 228, 230, 232, or 234 is used to signal the BSS color indicator for the AP, then a different one of the subfields 226, 228, 230, 232, or 234 could be used to signal the reference channel of the AP.

As an alternative to including the BSS color indicator in the trigger frame itself, the AP may instead set a rule that it will always send trigger frames that include RUs allocated for random access communications by unassociated STAs in a PPDU formatted according to IEEE 802.11ax or future formats. 11ax PPDUs (e.g., high efficiency (HE) PPDUs) will indicate the BSS color indicator in their PHY header (HE SIG field) to receiving stations regardless of what frames are included in the PPDU. In this implementation, the AP may determine that it is going to send a trigger frame with at least one RU allocated for random access communications by unassociated STAs. In response to this determination, the AP may ensure that it does not use a legacy (e.g., pre-11ax) PPDU format to send the trigger frame that includes an RU allocated for random access communications by unassociated STAs. As such the AP would carry the Trigger frame with at least one RU allocated for random access communications by unassociated STAs in an HE PPDU format.

At block 506, the AP outputs the trigger frame, which includes an indication of a reference channel associated with the AP or a BSS color indication, or both, for transmission to one or more STAs. In one implementation, a microchip or integrated circuit (e.g., a modem chip) that is a sub-component of the AP may output the trigger frame for eventual physical transmission over the air through other sub-components of the AP, such as a radio frequency transmitter and an antenna of the AP (and other radio frequency transmission components of the AP). In another implementation, the AP itself as an entire unit outputs the trigger frame for transmission by formatting the message data and generating the physical over-the-air transmission of the data of the trigger frame to be received by one or more STAs.

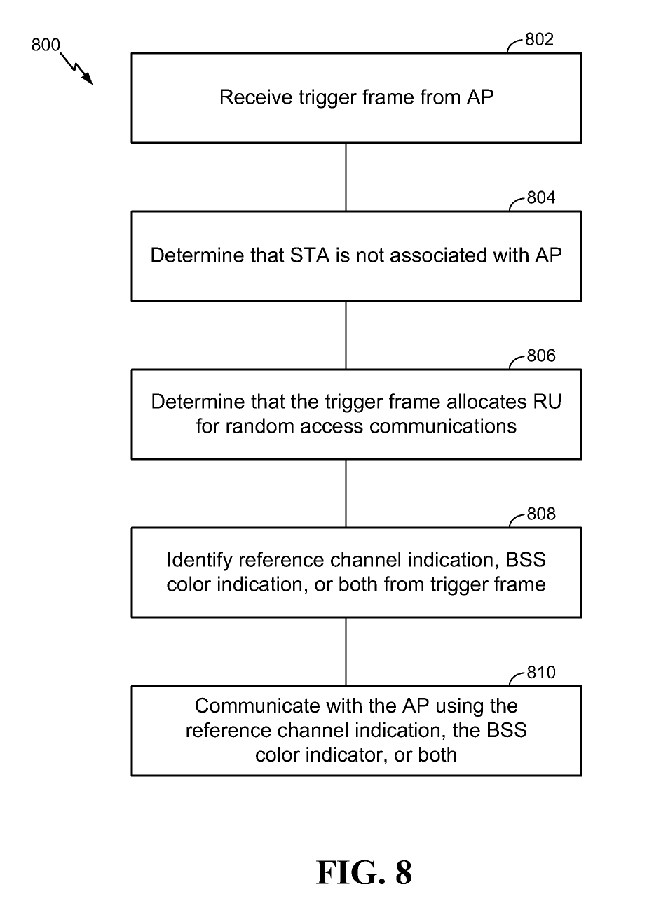

FIG. 8 is a flow diagram illustrating an example of a process 800 for identifying a reference channel indication or BSS color indication from a received trigger frame. In process 800, a wireless communication device may receive a trigger frame from a second device and determine a reference channel or BSS color indication used by the second device to assist the wireless communication device to respond to the trigger frame. The wireless communication device may be a STA (when receiving the trigger frame from an AP or another STA) or an AP (when receiving the trigger frame from a STA or another AP). Note that for the remainder of the description of this flow diagram, a STA (e.g., STA 115 of FIG. 4) will be described as the wireless communication device receiving and processing the trigger frame, although the trigger frame may be received by an AP (e.g., AP 105 of FIG. 3) in other implementations.

At block 802, the STA receives a trigger frame (e.g., the trigger frame 200 of FIG. 2) from an AP (or another device). At block 804, the STA reviews the data of the trigger frame and determines whether the STA is already associated with the AP. Alternatively, at block 804, the STA may determine whether it otherwise has any stored data regarding the AP. For example, the STA may determine whether it has stored the AP's reference channel or BSS color indication, each of which may be useful in responding to the trigger frame.

At block 806, assuming the STA is not already associated with the AP, the STA analyzes the trigger frame and determines whether the trigger frame allocates any RUs for random access operations by unassociated STAs. For example, the STA may make this determination by checking each AID12 field (such as the AID12 subfields included in each user information field 212, 214, or 216 included in the trigger frame 200) to see if the value of any AID12 field of the trigger frame has been set to 2045. If so, then the STA has identified a trigger frame that allocates at least one RU for random access operations by unassociated STAs. If not, and the STA is not associated with the AP, then the STA will not likely respond to the trigger frame.

At block 808, the STA identifies the reference channel indicator, the BSS color indicator, or both from the trigger frame. The STA will analyze the one or more portions of the trigger frame used to carry the reference channel indicator or the BSS color indicator. For example, depending on which area of the trigger frame selected by the AP at block 504 of FIG. 5, the STA may determine the desired information from the subfield 226 of the common information subfield 210 (FIG. 2), the subfield 232 of the padding subfield 218, the subfield 228 of the user information subfield 212 (or similarly the subfield 230 or the user information subfield 216), or the subfield 234 within the scrambler field 224. Where the AP repurposes one of these subfields to carry the reference channel indicator or the BSS color indicator (instead of the usual meaning of these subfields), the STA may know to interpret these subfields as containing the reference channel indicator or the BSS color indicator when the trigger frame includes an AID12 subfield with a value that equals 2045 (which indicates an RU is allocated for RA operation by an unassociated STA). When the AID12 subfield does not include a value that equals 2045, the STA may interpret the received data in these fields to mean something different than the reference channel indicator or the BSS color indicator.

At block 810, the STA may communicate with the AP that sent the trigger response by using the reference channel indicator, the BSS color indicator, or both, received from the trigger frame (in addition to using other information used to form a trigger based response). As one example, the STA may use the reference channel indicator to determine a location of the one or more RUs allocated for random access communications by mapping the one or more RUs relative to a location of the reference channel. Once the location of the RUs is determined, the STA can send a trigger based response to the trigger frame on the RUs allocated for random access communications by unassociated STAs. The trigger based response from the STA may include the BSS color indicator of the AP that the STA identified from the trigger frame.

FIG. 9 is a flow diagram illustrating an example of a process 900 for identifying a reference channel indication based on a location of a wireless communication device. In process 900, a wireless communication device may receive a trigger frame from a second device and determine a reference channel used by the second device to assist the wireless communication device to respond to the trigger frame. The wireless communication device may be a STA (when receiving the trigger frame from an AP or another STA) or an AP (when receiving the trigger frame from a STA or another AP). Note that for the remainder of the description of this flow diagram, a STA (e.g., STA 115 of FIG. 4) will be described as the wireless communication device receiving and processing the trigger frame, although the trigger frame may be received by an AP (e.g., AP 105 of FIG. 3) in other implementations.

At block 902, the STA receives a trigger frame (e.g., the trigger frame 200 of FIG. 2) from an AP (or another device). At block 904, the STA reviews the data of the trigger frame and determines whether the STA is already associated with the AP. Alternatively, at block 904, the STA may determine whether it otherwise has any stored data regarding the AP. For example, the STA may determine whether it has stored the AP's reference channel from a previous interaction with the AP. At block 906, assuming the STA is not already associated with the AP, the STA analyzes the trigger frame and determines whether the trigger frame allocates any RUs for random access operations by unassociated STAs. For example, the STA may make this determination by checking each AID12 field (such as the AID12 subfields included in each user information field 212, 214, or 216 included in the trigger frame 200) to see if the value of any AID12 field of the trigger frame has been set to 2045. If so, then the STA has identified a trigger frame that allocates at least one RU for random access operations by unassociated STAs. If not, and the STA is not associated with the AP, then the STA will not likely respond to the trigger frame.

At block 908, the STA determines its location. In one example, the STA determines its country of operation or its region of operation (a region may be larger or smaller than a country). The STA may determine its country or region by checking its Global Positioning System (GPS) coordinates against a reference map that corresponds to countries of operation or regions of operation. Each country or region may be assigned a fixed reference channel used by devices in that country or region. Thus, at block 910, the STA may determine the reference channel used by the AP that transmitted the trigger frame based on the current location (e.g., country or region) of the STA. The STA may store a lookup table that indicates the fixed reference channel for each country or region. Once the STA determines the appropriate reference channel for the AP that sent the trigger frame, the STA may communicate with the AP using the reference channel as described above in connection with block 810 of FIG. 8.

In another implementation, each country or region has a known fixed dedicated control channel. Once the STA determines its location, it may then tune to the control channel dedicated to this country/region to listen and receive any incoming trigger frames. The STA then knows that the same channel it used to receive the trigger frame is the reference channel used by the AP for RU mapping purposes. The STA may determine the location of the allocated RUs by mapping the RUs relative to this reference/control channel. In this implementation, multiple control channels are possible as long as the spacing between the channels is orthogonal.

FIG. 10 is a flow diagram illustrating an example of a process 1000 for aggregating a trigger frame with another frame to provide a reference channel indication or BSS color indication to a device that receives the aggregated data unit. In process 1000, a wireless communication device, such as an AP (for triggering a STA to generate a trigger-based response) or a STA (for triggering another STA to generate a trigger-based response) generates a trigger frame. Note that for the remainder of the description of this flow diagram, an AP (e.g., AP 105 of FIG. 3) will be described as the wireless communication device sending the trigger frame, although the trigger frame may be generated by a STA (e.g., STA 115 of FIG. 4) in other implementations.

At block 1002, the AP determines that it will be sending a trigger frame (e.g., the trigger frame 200 of FIG. 2) that allocates one or more RUs for random access communications by one or more STAs that are currently unassociated with the AP, as described above in more detail in connection with block 502 of FIG. 5. For example, the AP may use a value of 2045 in the AID12 subfield 602 (FIG. 6) of a trigger frame to signal that the trigger frame includes one or more RUs for random access communications by one or more STAs that are currently unassociated with the AP.

At block 1004, the AP that will send the trigger frame selects a second frame to aggregate with the trigger frame in an aggregated data unit (e.g., an A-MPDU). As discussed above in connection with FIG. 5, a STA that is not associated with the AP and receives a traditional trigger frame (e.g., one that does not otherwise signal a reference channel used by the AP or the BSS color indicator used by the AP) may not know the reference channel used by the AP or the BSS color indicator used by the AP. Thus, the AP selects the second frame for aggregation because the second frame is a frame formatted to include a reference channel indicator used by the AP, a BSS color indicator, or both. Furthermore, where the second frame includes only one of the reference channel indicator or the BSS color indicator, the AP may select a third frame that includes the other one of the reference channel indicator or the BSS color indicator. The AP may then aggregate these multiple frames (e.g., two frames, three frames, or more) into the aggregated data unit to provide the reference channel indicator and the BSS color indicator to unassociated STAs that receive the aggregated data unit. A STA receiving the aggregated data unit will associate the parameters received from the second frame (or any other frame) aggregated with the trigger frame to the AP that sent the trigger frame. Thus, even if the trigger frame does not signal its reference channel or include the BSS color indicator, the STA can determine these parameters from other frames aggregated together with the trigger frame.

At block 1004, the AP may select from several different types of frames that include the AP's reference channel and/or BSS color. In one implementation, the AP may select to aggregate the trigger frame with a probe response frame, such as a broadcast probe response frame. A probe response frame may be formatted to carry information related to a first channel number (via the country element), which serves as the reference channel for the AP, and information related to the BSS color (via the high efficiency (HE) operation element). Because this frame includes the BSS color indicator, the A-MPDU carrying the trigger frame and the probe response can even be sent in a legacy (earlier than IEEE 802.11ax) PPDU and still relay the BSS color information to the receiving STAs. The probe response also includes additional pieces of information that can be used by a receiving STA to determine whether the AP is a suitable candidate for association. When a probe response is aggregated together with the trigger frame, the STA will have the benefit of this additional information to decide whether it even wants to respond to the trigger frame by using the random access RUs. If the AP is not suitable for the STA and elects not to respond, then it reduces congestion and contention for the random access RUs allocated.

In another implementation, the AP may select to aggregate the trigger frame with a fast initial link setup (FILS) discovery frame. The FILS discovery frame may be shorter than a probe response frame and thus may reduce the amount of data needing to be transmitted in the aggregated data unit. The FILS discovery frame may also be transmitted at a higher data rate than a probe response in some implementations. The FILS discovery frame can be extended to carry the reference channel indicator and the BSS color indication.

In yet another implementation, the AP may select to aggregate the trigger frame with a newly defined action frame that is even shorter than the FILS discovery frame (and shorter than the probe response) that focuses on carrying the reference channel indicator, the BSS color, or both. This new action frame may only carry these two pieces of data (in addition to any needed header fields) or may optionally include other data helpful to determine whether the AP is a suitable candidate for communications with the STA.

In the description of block 1004 above, the focus was on selecting a second frame that included the AP's reference channel and/or BSS color indication. However, alternative implementations may focus on selecting a second frame that includes some other attribute, property, or characteristic of the AP or the BSS which may otherwise be unknown to unassociated STAs before beginning communication with the AP. These obscure attributes are not generally known to unassociated STAs unless they receive the information in some type of management frame from the AP. The AP may decide to aggregate the trigger frame with a second frame because the second frame includes some other characteristics or information of the AP or BSS that is different than the BSS color and the AP's reference channel (or in addition to the BSS color and/or the AP's reference channel).

At block 1006, the AP aggregates the one or more selected secondary frames with the trigger frame into an aggregated data unit. For example, the aggregated data unit may be an A-MPDU. If the BSS color information is included somewhere in one of the frames in the aggregated data unit, then the AP may send the aggregated data unit according to either a legacy format (e.g., pre-11ax) or a newer format (11ax and future). If the BSS color is not included in one of the frames in the aggregated data unit (but the AP's reference channel indicator is included in at least one of the frames), then the AP can still signal the BSS color information by ensuring the aggregated data unit is transmitted as PPDU of the newer format (11ax and future). At block 1008, the AP outputs the aggregated data unit for transmission to one or more STAs, similar to the description above of outputting the trigger frame in connection with block 506 of FIG. 5.

FIG. 11 is a flow diagram illustrating an example of a process 1100 for identifying a reference channel indication or BSS color indication for a trigger frame from a second frame aggregated with a trigger frame. In process 1100, a wireless communication device may receive an aggregated data unit from a second device and determine a reference channel or BSS color indication used by the second device to assist the wireless communication device to respond to a trigger frame included in the aggregated data unit. The wireless communication device may be a STA (when receiving the trigger frame from an AP or another STA) or an AP (when receiving the trigger frame from a STA or another AP). Note that for the remainder of the description of this flow diagram, a STA (e.g., STA 115 of FIG. 4) will be described as the wireless communication device receiving and processing the trigger frame, although the trigger frame may be received by an AP (e.g., AP 105 of FIG. 3) in other implementations.

At block 1102, the STA receives an aggregated data unit (e.g., A-MPDU) from an AP (or another device). At block 1104, the STA reviews the data of the aggregated data unit and determines whether the STA is already associated with the AP. Alternatively, at block 1104, the STA may determine whether it otherwise has any stored data regarding the AP. For example, the STA may determine whether it has stored the AP's reference channel or BSS color indication, each of which may be useful in responding to a trigger frame included within the aggregated data unit. At block 1106, assuming the STA is not already associated with the AP, the STA analyzes aggregated data unit and determines the data unit includes a trigger frame that allocates one or more RUs for random access operations by unassociated STAs. For example, the STA may make this determination by checking each AID12 field (such as the AID12 subfields included in each user information field 212, 214, or 216 included in the trigger frame 200 of FIG. 2) to see if the value of any AID12 field of the trigger frame has been set to 2045. If so, then the STA has identified a trigger frame that allocates at least one RU for random access operations by unassociated STAs. If not, and the STA is not associated with the AP, then the STA will not likely respond to the trigger frame.

At block 1108, the STA identifies one or more second frames (e.g., a probe response, a FILS discovery frame, or another action frame that includes the desired information) in the aggregated data unit that include the reference channel indicator, the BSS color indicator, or both. At block 1110, the STA associates the reference channel indicator and the BSS color indicator with the AP that sent the aggregated data unit and thus also with any other frames included in the aggregated data unit. For example, the STA may associate the reference channel indicator and the BSS color indicator with the other information of the trigger frame (e.g., the RUs allocated for random access communications) so that the STA can fully form a trigger-based response to the trigger frame included in the aggregated data unit.

At block 1112, the STA may communicate with the AP that sent the trigger response contained in the aggregated data unit by using the reference channel indicator, the BSS color indicator, or both, received from the other frames or fields of the aggregated data unit (in addition to using other information used to form a trigger based response). As one example, the STA may use the reference channel indicator to determine a location of the one or more RUs allocated for random access communications by mapping the one or more RUs relative to a location of the reference channel. Once the location of the RUs is determined, the STA can send a trigger based response to the trigger frame on the RUs allocated for random access communications by unassociated STAs. The trigger based response from the STA may include the BSS color indicator of the AP that the STA identified from the aggregated data unit.

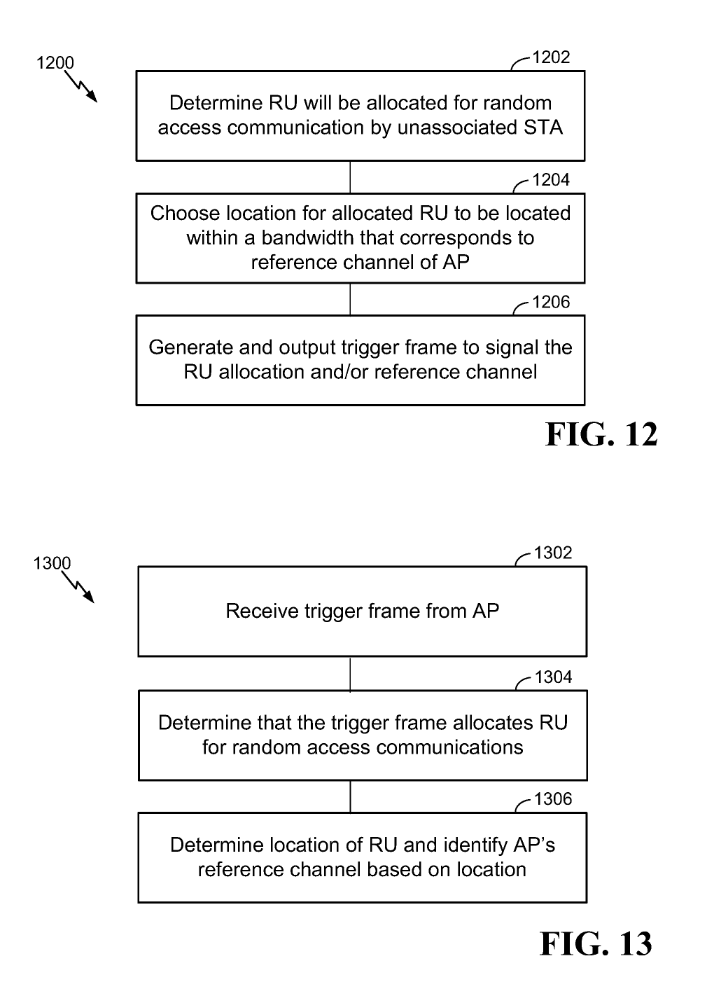

FIG. 12 is a flow diagram illustrating an example of a process 1200 for signaling a reference channel indication by allocating one or more resource units within the reference channel (e.g., the AP's primary 20 MHz channel or any other size primary channel). In process 1200, a wireless communication device, such as an AP (for triggering a STA to generate a trigger-based response) or a STA (for triggering another STA to generate a trigger-based response) generates a trigger frame. Note that for the remainder of the description of this flow diagram, an AP (e.g., AP 105 of FIG. 3) will be described as the wireless communication device sending the trigger frame, although the trigger frame may be generated by a STA (e.g., STA 115 of FIG. 4) in other implementations.

At block 1202, the AP may determine that it will be allocating one or more RUs for random access communication by one or more STAs that are currently unassociated with the AP. At block 1204, the AP may choose a location within the total available bandwidth to position the allocated RU(s). As discussed above, in some situations, a STA may not know the reference channel (e.g., primary channel, such as a primary 20 MHz channel) associated with a specific AP. Thus, the AP may signal this reference channel indication to the STA in some way, either explicitly or implicitly. In the implementation of FIG. 12, the AP implicitly signals which reference channel it is using as its primary channel by limiting its allocation of RUs for unassociated STAs to only be in RUs that fall within the AP's primary reference channel. For example, the AP may determine that it will be allocating an RU for an unassociated STA. In response that that determination, the AP will only select from a subset of all possible RUs for the allocation. The subset of RUs available for this type of selection will be the RUs within the primary channel. The AP will not select from RUs that would be on one of the AP's secondary channels when considering communication with unassociated STAs. By limiting allocation of the RU to only be within the primary reference channel, the receiving STAs can take this selection by the AP as an implicit indication that the channel that contains the allocated RUs is the AP's primary reference channel. Although this signaling option may limit the number of RUs available for use for unassociated STAs, it will allow the AP to signal its primary reference channel without having to include an explicit reference channel indication in some other portion of the trigger frame or other frame (or by some other signaling technique).

At block 1206, the AP generates and outputs a trigger frame to signal the RU allocation to any receiving STAs. The AP may also use the trigger frame to signal its primary reference channel by use of the implicit signaling technique discussed at block 1204. Additionally or alternatively, the AP may signal its primary reference channel by transmitting the trigger frame only on its primary reference channel. For example, in this implementation, the receiving STAs may infer that the channel used for sending the downlink trigger frame will be the sending AP's reference channel regardless of where the RUs for future uplink communication are allocated. However, in other implementations, the AP may want to duplicate the trigger frame on multiple different channels, including the primary reference channel and at least one other secondary channel. By duplicating on multiple channels (or even on all primary and secondary channels), the AP may be able to communicate with more possible unassociated STAs (e.g., some STAs may be listening to different channels). In this situation (where duplication is used), the AP may use the implicit primary reference channel signaling discussed at block 1204, which allows the receiving STA to determine the primary reference channel based on the location of the RUs allocated for future uplink communication by unassociated STAs.

FIG. 13 is a flow diagram illustrating an example of a process 1300 for identifying a reference channel based on a location of one or more allocated resource units. In process 1300, a wireless communication device may receive a trigger frame from a second device and determine the primary reference channel used by the second device to assist the wireless communication device to respond to the trigger frame. The wireless communication device may be a STA (when receiving the trigger frame from an AP or another STA) or an AP (when receiving the trigger frame from a STA or another AP). Note that for the remainder of the description of this flow diagram, a STA (e.g., STA 115 of FIG. 4) will be described as the wireless communication device receiving and processing the trigger frame, although the trigger frame may be received by an AP (e.g., AP 105 of FIG. 3) in other implementations.

At block 1302, the STA receives and processes an incoming trigger frame (e.g., the trigger frame 200 of FIG. 2) from an AP (or another device). At block 1304, assuming the STA is not already associated with the AP, the STA analyzes the trigger frame and determines whether the trigger frame allocates any RUs for random access operations by unassociated STAs. For example, the STA may make this determination by checking each AID12 field (such as the AID12 subfields included in each user information field 212, 214, or 216 included in the trigger frame 200) to see if the value of any AID12 field of the trigger frame has been set to 2045. If so, then the STA has identified a trigger frame that allocates at least one RU for random access operations by unassociated STAs. If not, and the STA is not associated with the AP, then the STA will not likely respond to the trigger frame.

At block 1306, the STA determines a location of the RU(s) allocated by the trigger frame and identifies the sending AP's primary reference channel based on the location of the allocated RU(s), as discussed above in connection with FIG. 12. For example, the STA may identify the channel that contains the allocated RU(s) as the sending AP's primary reference channel. As an alternative, the STA may infer the location of the AP's primary reference channel based on the trigger frame being received on a specific channel. The STA may identify the channel used as the trigger frame channel as the AP's primary reference channel based on this channel usage. In either case (e.g., inferring the primary reference channel from either (1) the location of the allocated RU(s) or (2) the channel used for the downlink trigger frame), the STA may use the knowledge of the AP's primary reference channel to support further communication with the AP.

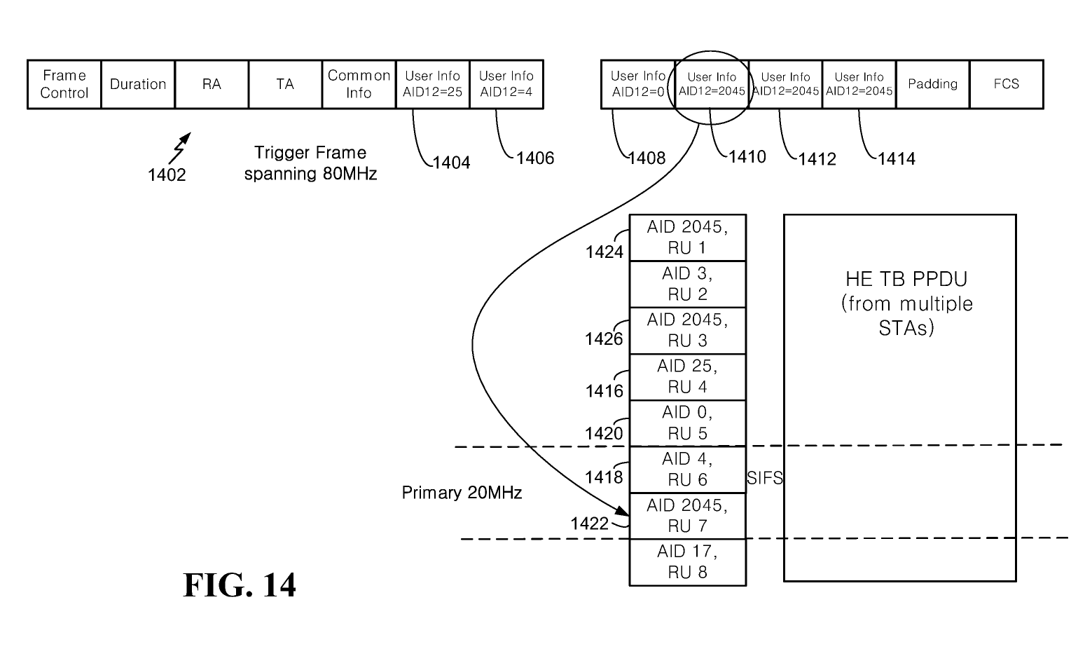

FIG. 14 is a frame diagram showing one example of a technique for signaling a primary reference channel indication by allocating a specific resource unit to be located within the primary reference channel. As discussed above in connection with FIGS. 12 and 13, a first device (e.g., an AP) may implicitly signal which channel it is using as its primary reference channel by limiting its allocation of at least one specific RU for other devices (e.g., unassociated STAs) to only be in an RU that falls within the first device's primary reference channel. In some implementations of FIGS. 12 and 13, all RUs allocated for random access communications by unassociated STAs may be limited to being located within the AP's primary reference channel (e.g., primary 20 MHz). However, in other implementations of FIGS. 12 and 13, not all RUs allocated for random access communications will need to be so limited. FIG. 14 illustrates one example where the AP may limit the allocation of one RU for random access communications by unassociated STAs to be located within the AP's primary reference channel, but also allocates one or more other RUs for random access communications by unassociated STAs in RUs located outside of the bandwidth of its primary reference channel. This flexibility allows the AP to implicitly signal its reference channel through the location of one RU allocation for unassociated STAs while still allowing other RU allocations for unassociated STAs to be located in other channels.

FIG. 14 illustrates a trigger frame 1402 that allocates various RUs for different categories of STAs (e.g., RUs targeted for specific associated states, an RU for all associated STAs, and RUs for all unassociated STAs). Other trigger frames within the scope of this disclosure could include any combination of RU allocation types. For example, all of the RUs allocated in a first example trigger frame could be directed to specific individual STAs, all of the RUs allocated in a second example trigger frame could be for random access RUs for associated STAs, all of the RUs allocated in a third example trigger frame could be for random access RUs for unassociated STAs, or the RUs in a fourth example trigger frame could include any combination of the three different categories of STAs (directed, random access for associated STAs, and random access for unassociated STAs). The trigger frame 1402 includes user information fields 1404, 1406, 1408, 1410, 1412, and 1414. In some implementations, the trigger frame 1402 will position the user information fields that allocate an RU for random access communications after all the user information fields in the trigger frame that allocate an RU for directed communications by an individual STA. As shown in FIG. 14, the user information fields 1408, 1410, 1412, and 1414 (which each allocate an RU for random access communications) are positioned after the user information fields that allocate RUs for directed communications by individual STAs (see, e.g., station information fields 1404 and 1406).

User information field 1404 allocates an RU 1416 for a specific targeted STA with a station identification value of 25 (carried in the AID12 field). This STA is already associated with the AP and has been assigned a specific station identification value (AID value) that uniquely identifies the STA relative to other STAs associated with the AP. In response to the trigger frame 1402, the STA associated with the AID12 value of 25 may send a trigger-based message to the device (e.g., AP) that sent the trigger frame 1402 on the RU 1416 allocated for the STA. Similar to the user information field 1404, the user information field 1406 also allocates an RU for a specific targeted STA (here, RU 1418 for the STA associated with the AID12 value of 4). Other user information fields (not shown) of the trigger frame 1402 may allocate additional RUs for other specific targeted stations (e.g., STAs assigned AID values of 3 and 17 in RUs 2 and 8 in FIG. 14). User information field 1408 allocates an RU 1420 for random access communications by a group of STAs, specifically any STA that is already associated with the AP that sent the trigger frame 1402 but wants to use random access communication procedures to communicate with the AP (e.g., the STA may not have been allocated its own directed RU). Because these STAs are each already associated with the AP that sent the trigger frame, they will already know the primary reference channel of the AP.

User information field 1410 allocates an RU 1420 for random access communications by STAs that are unassociated with the device (e.g., AP) that sent the trigger frame 1402. User information field 1410 is the first field in the trigger frame 1402 that allocates an RU for STAs that are unassociated with the AP that sent the trigger frame 1402. For example, the user information field 1410 is the first user information field with an AID12 value of 2045 that an unassociated STA would decode when parsing through a frame looking for a field that allocates an RU for unassociated STAs. Because unassociated STAs may not know the primary reference channel of the AP that sent the trigger frame 1402, the AP may signal its primary reference channel to receiving STAs in some way. One way to implicitly signal the AP's primary reference channel is to limit the selection of an RU for the first RU allocation for unassociated STAs to be located within the AP's primary reference channel. A STA receiving this trigger frame will then know to identify whichever channel carries the RU allocated by the first user information field for unassociated STAs of the trigger frame as the primary reference channel of the sending device. The second, third, fourth, or other subsequent RU allocations that follow the first RU allocation need not be so limited in placement within the available spectrum. For example, while the RU 1422 allocated by the user information field 1410 may be limited to being within the AP's primary reference channel (to signal the AP's primary reference channel), the RUs 1424 and 1426 allocated by the user information fields 1412 and 1414 may be located anywhere within the available bandwidth. The STAs desiring to use RUs 1424 or 1426 may first decode the user information field 1410 to identify the AP's primary reference channel before moving to user information field 1412 or 1414 to determine the location of the desired RU (e.g., RU 1424 or 1426) that are outside of the AP's primary reference channel. As one example, as shown in FIG. 14, where the trigger frame spans 80 MHz and the primary reference channel is 20 MHz, the RU 1422 associated with the first user information field 1410 in the trigger frame 1402 may be limited to being positioned within the primary 20 MHz reference channel, and the RUs 1424 and 1426 allocated by the user information fields 1412 and 1414 may be located outside (or even inside in other examples) of the primary 20 MHz reference channel.

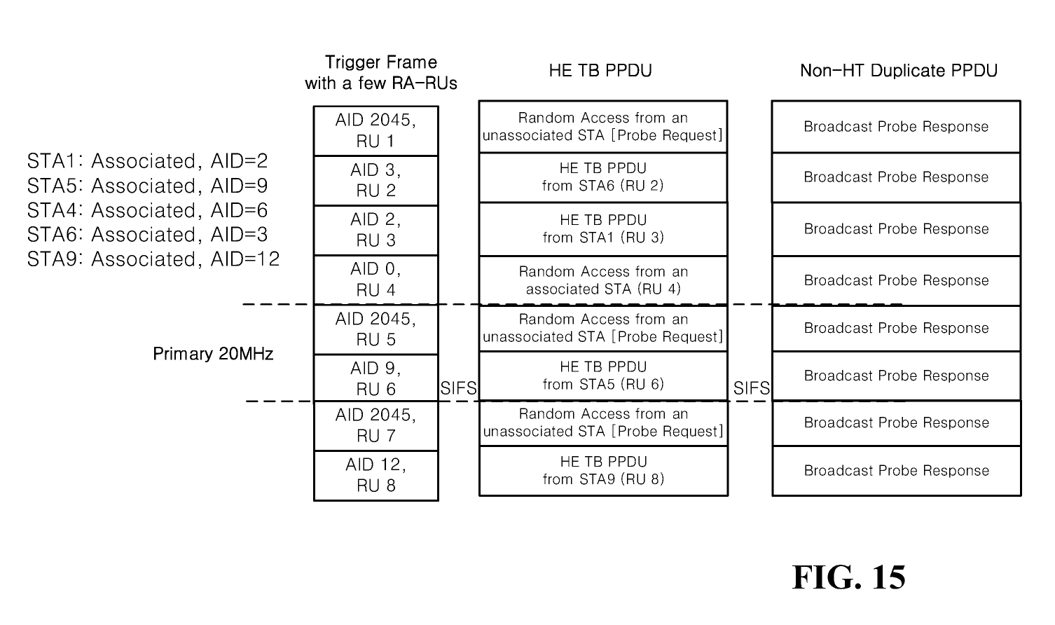

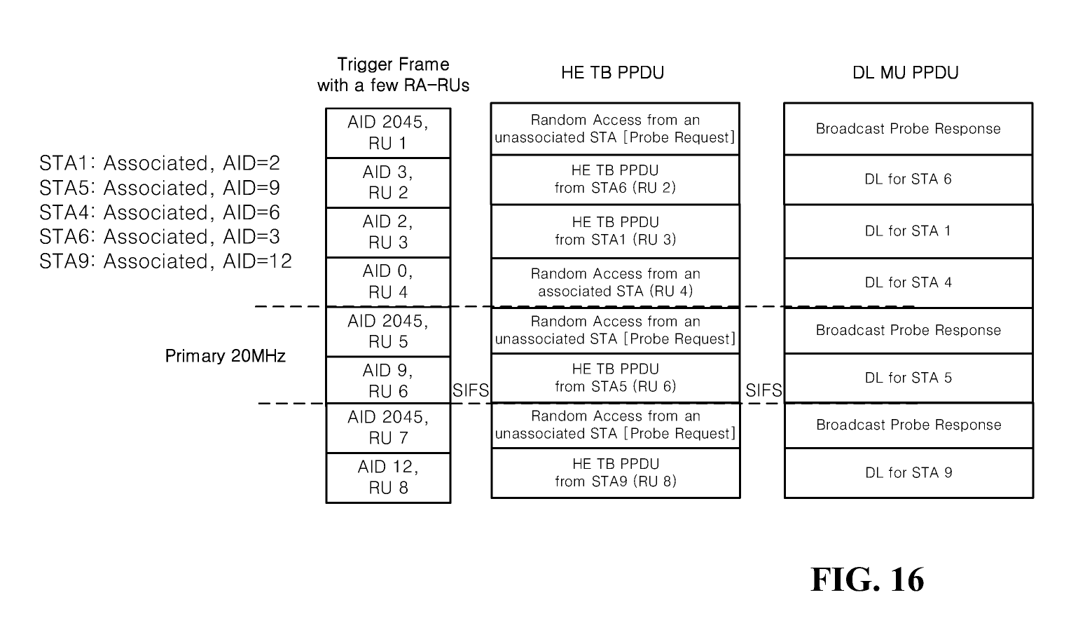

In one implementation, the RUs allocated by an AP's trigger frame for unassociated STAs may be located anywhere in the available spectrum, either inside or outside of the AP's primary reference channel. For example, in the example of FIG. 14, the trigger frame 1402 allocates RUs 1424 and 1426 outside of the AP's primary reference channel. When an unassociated STA uses one of these RUs that are outside of the primary reference channel to send a probe request to the AP, the AP may respond with a broadcast probe response in a duplicate format where the message is duplicated on multiple channels (e.g., duplicated to be on every 20 MHz channel). For example, FIG. 15 illustrates an example where an AP sends a duplicate PPDU containing broadcast probe response duplicates on all the sub-channels of the wide-band channel. In other implementations, an AP may send a downlink multi-user PPDU with RUs addressed to unassociated STAs (e.g., with STA ID=2045) located at the same location as the uplink RU used by the unassociated STA to send probe request frame. The AP may send a PPDU within such RUs carrying unicast or broadcast probe response frames as a response. For example, FIG. 16 illustrates an example where an AP sends a probe response on the same RU used by an unassociated STA for the uplink probe request. With these mechanisms (e.g., shown in FIGS. 15 and 16), a STA on a secondary channel (e.g., the AP's secondary 20 MHz) may still receive a response to its probe request even though it was not sent on the AP's primary channel. The AP's response frame carries the information that indicates the location of the AP's primary channel along with other information. Although FIGS. 15 and 16 illustrate examples using probe request and probe response exchanges, other message exchanges (e.g., an association request sequence or other message exchange) may also use these same techniques (duplication or using the same RU as the uplink).

The descriptions herein describe various explicit or implicit signaling techniques that allow a first device (e.g., AP) to inform a second device (e.g., STA) about the primary reference channel used by the first device. In some implementations, the AP may only have a single primary reference channel. Thus, in these implementations, the AP may only signal one primary reference channel in a trigger frame via explicit or implicit signaling. In other implementations, the AP may use multiple primary reference channels (e.g., 2, 3, 4, or more). As one example of a multiple primary reference channel situation, an AP may operate in an 80+80 mode where the AP has a discontinuous 160 MHz bandwidth (two separate 80 MHz bandwidths) and each 80 MHz bandwidth has a different primary reference channel. As another example, the AP may operate in a 160+160 mode where the AP has a discontinuous 320 MHz bandwidth (two separate 160 MHz bandwidths) and each 160 MHz bandwidth has a different primary reference channel. In these implementations, the AP may signal the two different primary reference channels in the same trigger frame. The AP may use the various types of explicit or implicit signaling discussed herein to allow multiple different user information fields in one trigger frame, multiple different trigger dependent user information fields in one trigger frame, or multiple other signaling locations in one trigger frame to signal different primary reference channels. For example, a first user information field may be associated with the AP's first 80 MHz and a second user information field may be associated with the AP's second 80 MHz in an 80+80 mode. Even though the first and second user information fields may both be within one trigger frame, the first user information field may signal a different primary reference channel than the second user information field due to the AP having two different primary reference channels.

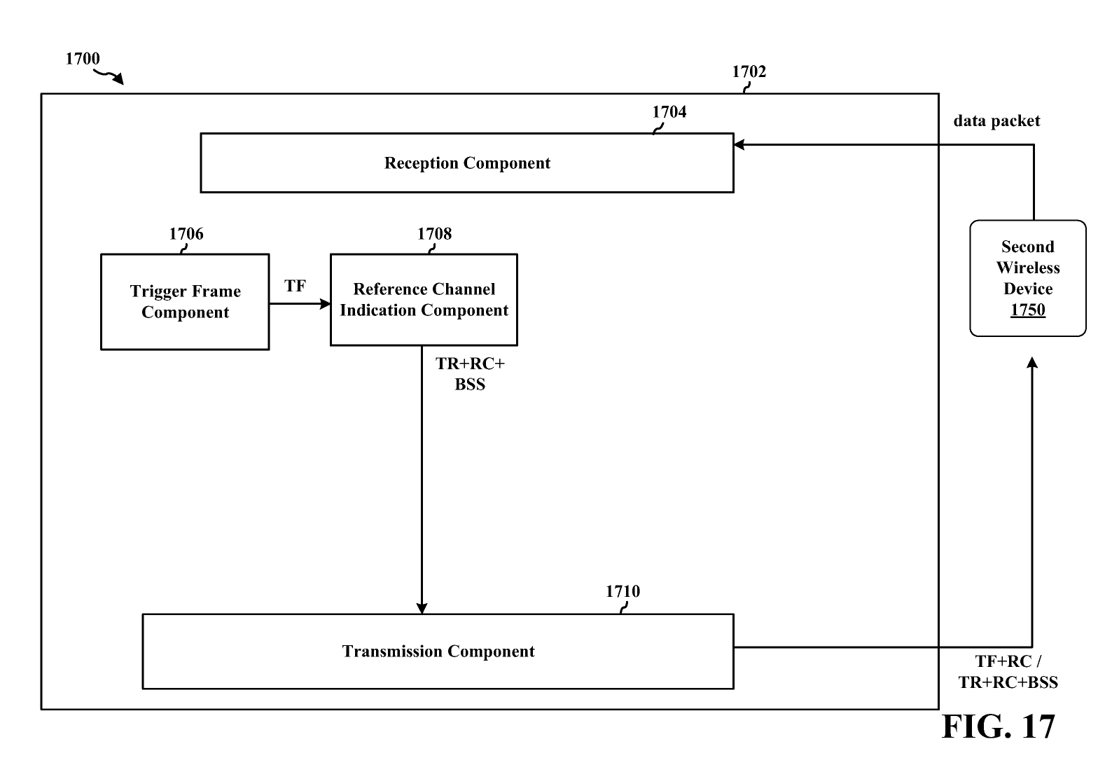

FIG. 17 is a conceptual data flow diagram 1700 illustrating the data flow between different means/components in an exemplary apparatus 1702. The apparatus 1702 may include an AP (for triggering a STA to generate a trigger-based response) or a STA (for triggering another STA to generate a trigger-based response) generates a trigger frame. Note that for the remainder of the description of FIG. 17, an AP (e.g., AP 105 of FIG. 3) will be described as the apparatus 1702 sending the trigger frame, although the trigger frame may be generated by a STA (e.g., STA 115 of FIG. 4) in other implementations. The apparatus 1702 may include a reception component 1704, a trigger frame component 1706, a reference channel indication component 1708, and the transmission component 1710.

The trigger frame component 1706 may be configured to determine a trigger frame will allocate RU for random access communications by unassociated STAs, e.g., as described in connection with operation 502 in FIG. 5. The trigger frame may be sent to the reference channel indication component 1708.

The reference channel indication 1708 may be configured to add reference channel indication, BSS color indication, or both to the trigger frame, e.g., as described in connection with operation 50 in FIG. 5. The trigger frame with the reference channel indication, BSS color indication, or both to the transmission component 1710.

The transmission component 1710 may be configured to output the trigger frame for transmission to STAs, e.g., as described in connection with operation 508 in FIG. 5.

The apparatus may include additional components that perform each of the blocks of the algorithm in the aforementioned flowchart of FIG. 5. As such, each block in the aforementioned flowchart of FIG. 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

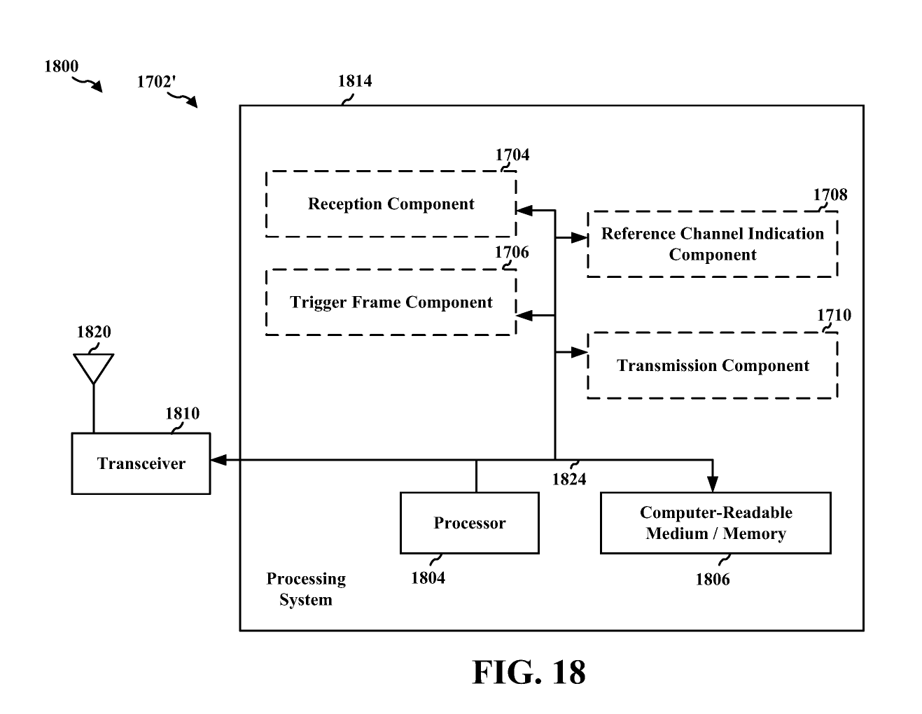

FIG. 18 is a diagram 1800 illustrating an example of a hardware implementation for an apparatus 1702′ employing a processing system 1814. The processing system 1814 may be implemented with a bus architecture, represented generally by the bus 1824. The bus 1824 may include any number of interconnecting buses and bridges depending on the specific application of the processing system 1814 and the overall design constraints. The bus 1824 links together various circuits including one or more processors and/or hardware components, represented by the processor 1804, the components 1704, 1706, 1708, 1710, and the computer-readable medium/memory 1806. The bus 1824 may also link various other circuits such as timing sources, peripherals, voltage regulators, and power management circuits, which are well known in the art, and therefore, will not be described any further.

The processing system 1814 may be coupled to a transceiver 1810. The transceiver 1810 is coupled to one or more antennas 1820. The transceiver 1810 provides a means for communicating with various other apparatus over a transmission medium. The transceiver 1810 receives a signal from the one or more antennas 1820, extracts information from the received signal, and provides the extracted information to the processing system 1814, specifically the reception component 1704. In addition, the transceiver 1810 receives information from the processing system 1814, specifically the transmission component 1710, and based on the received information, generates a signal to be applied to the one or more antennas 1820. The processing system 1814 includes a processor 1804 coupled to a computer-readable medium/memory 1806. The processor 1804 is responsible for general processing, including the execution of software stored on the computer-readable medium/memory 1806. The software, when executed by the processor 1804, causes the processing system 1814 to perform the various functions described supra for any particular apparatus. The computer-readable medium/memory 1806 may also be used for storing data that is manipulated by the processor 1804 when executing software. The processing system 1814 further includes at least one of the components 1704, 1706, 1708, 1710. The components may be software components running in the processor 1804, resident/stored in the computer readable medium/memory 1806, one or more hardware components coupled to the processor 1804, or some combination thereof.

In certain configurations, the apparatus 1702/1702′ for wireless communication may include means for determining a trigger frame will allocate RU for random access communications by unassociated STAs, e.g., as described in connection with operation 502 in FIG. 5. In certain other configurations, the apparatus 1702/1702′ for wireless communication may include means for adding a reference channel indication, BSS color indication, or both to the trigger frame, e.g., as described in connection with operation 506 in FIG. 5. In certain other configurations, the apparatus 1702/1702′ for wireless communication may include means for outputting trigger frame for transmission to STAs, e.g., as described in connection with operation 508 in FIG. 5. The aforementioned means may be the processor(s) 202, the radio, the MMU 240, short-range communications controller 252, one or more of the aforementioned components of the apparatus 1702 and/or the processing system 1814 of the apparatus 1702′ configured to perform the functions recited by the aforementioned means.

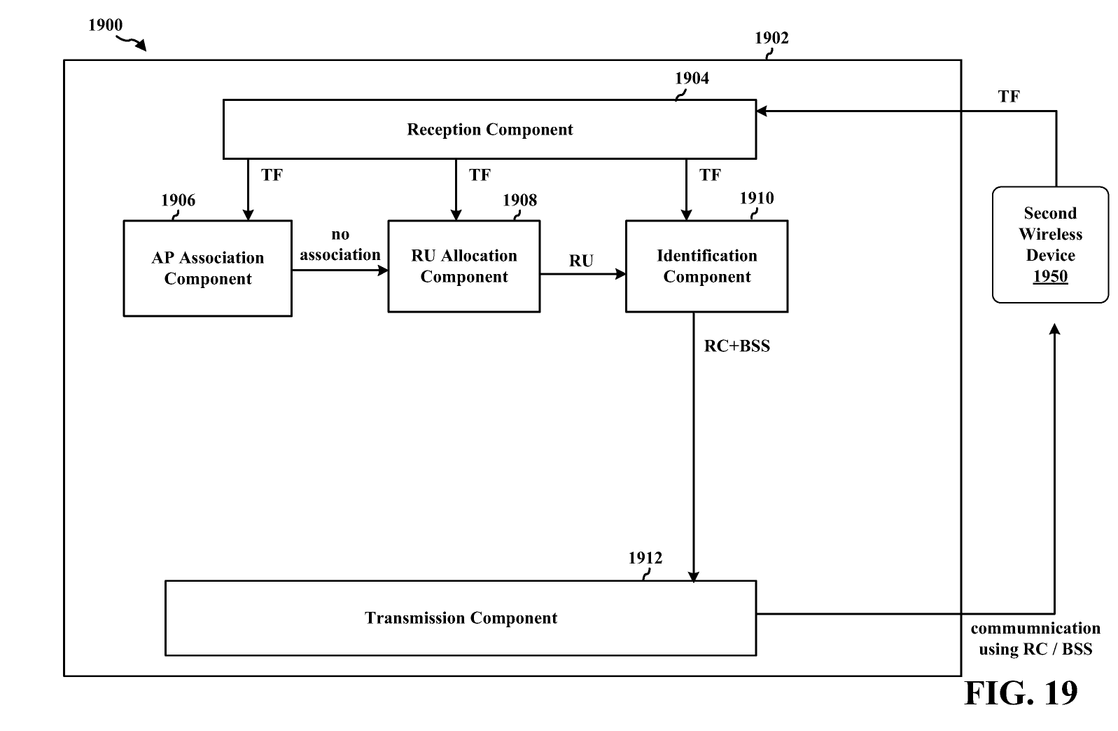

FIG. 19 is a conceptual data flow diagram 1900 illustrating the data flow between different means/components in an exemplary apparatus 1902. The apparatus 1902 may be may be a STA (when receiving the trigger frame from an AP or another STA) or an AP (when receiving the trigger frame from a STA or another AP) in communication with a second wireless device 1950 (e.g., AP 105 in FIG. 4 or STA 115 in FIG. 3). Note that for the remainder of the description of FIG. 19, a STA (e.g., STA 115 of FIG. 4) will be described as the apparatus 1902 receiving and processing the trigger frame, although the trigger frame may be received by an AP (e.g., AP 105 of FIG. 3) in other implementations. The apparatus 1902 may include a reception component 1904, an AP association component 1906, an RU allocation component 1908, an identification component 1910, and a transmission component 1912.

The reception component 1904 may be configured to receive a trigger frame from the second wireless device 1950, e.g., as described in connection with operation 802 in FIG. 8. The trigger frame may be sent to the AP association component 1906, the RU allocation component 1908, and the identification component 1910.

The AP association component 1906 may be configured to determine that the apparatus 1905 is not associated with an AP (e.g., the second wireless device 1950, e.g., as described in connection with operation 804 in FIG. 8. The AP association component 1906 may send an indication that the apparatus 1902 is not associated with an AP to the RU allocation component 1908.

The RU allocation component 1908 may be configured to determine that the trigger frame allocates RU for random access communications, e.g., as described in connection with operation 806 in FIG. 8. The RU allocation component 1908 may send an information associated with the RU to the identification component 1910.

The identification component 1910 may be configured to identify a reference channel indication, BSS color indication, or both from the trigger frame, e.g., as described in connection with the operation 808 in FIG. 8. The trigger frame and information associated with the reference channel indication, BSS color indication, or both may be sent to the transmission component 1912.

The transmission component 1912 may be configured to communicate with the AP (e.g., second wireless device 1950) using the reference channel indication, the BSS color indicator, or both, e.g., as described in connection with operation 810 in FIG. 5.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

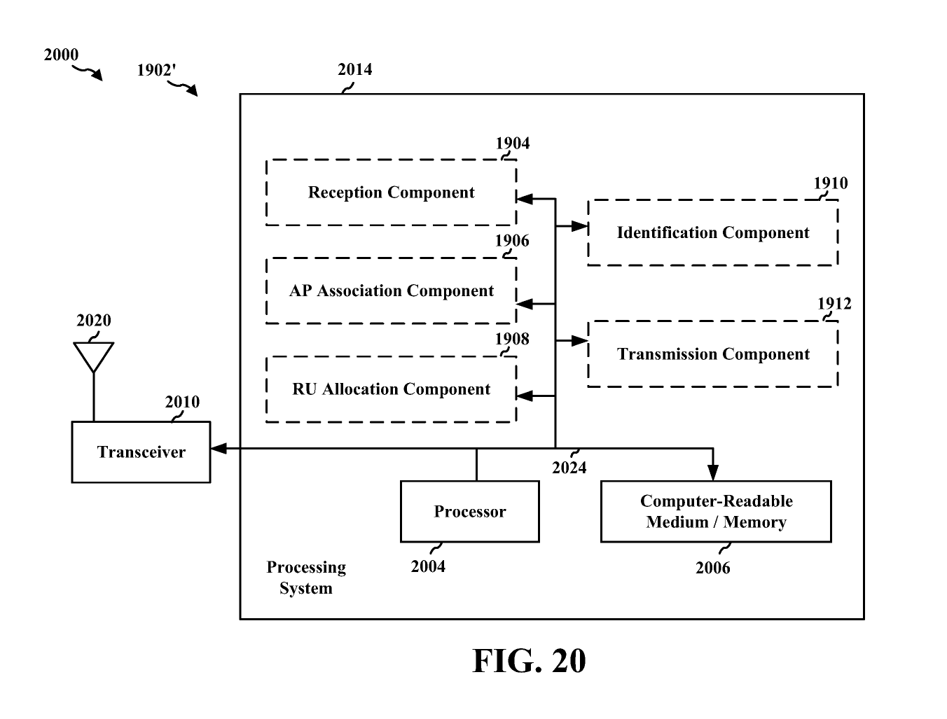

FIG. 20 is a diagram 2000 illustrating an example of a hardware implementation for an apparatus 1902′ employing a processing system 2014. The processing system 2014 may be implemented with a bus architecture, represented generally by the bus 2024. The bus 2024 may include any number of interconnecting buses and bridges depending on the specific application of the processing system 2014 and the overall design constraints. The bus 2024 links together various circuits including one or more processors and/or hardware components, represented by the processor 2004, the components 1904, 1906, 1908, 1910, 1912, and the computer-readable medium/memory 2006. The bus 2024 may also link various other circuits such as timing sources, peripherals, voltage regulators, and power management circuits, which are well known in the art, and therefore, will not be described any further.

The processing system 2014 may be coupled to a transceiver 2010. The transceiver 2010 is coupled to one or more antennas 2020. The transceiver 2010 provides a means for communicating with various other apparatus over a transmission medium. The transceiver 2010 receives a signal from the one or more antennas 2020, extracts information from the received signal, and provides the extracted information to the processing system 2014, specifically the reception component 1904. In addition, the transceiver 2010 receives information from the processing system 2014, specifically the transmission component 1912, and based on the received information, generates a signal to be applied to the one or more antennas 2020. The processing system 2014 includes a processor 2004 coupled to a computer-readable medium/memory 2006. The processor 2004 is responsible for general processing, including the execution of software stored on the computer-readable medium/memory 2006. The software, when executed by the processor 2004, causes the processing system 2014 to perform the various functions described supra for any particular apparatus. The computer-readable medium/memory 2006 may also be used for storing data that is manipulated by the processor 2004 when executing software. The processing system 2014 further includes at least one of the components 1904, 1906, 1908, 1910, 1912. The components may be software components running in the processor 2004, resident/stored in the computer readable medium/memory 2006, one or more hardware components coupled to the processor 2004, or some combination thereof.

In certain configurations, the apparatus 1902/1902′ for wireless communication may include means for receiving trigger frame from AP, e.g., as described in connection with operation 802 in FIG. 8. In certain other configurations, the apparatus 1902/1902′ for wireless communication may include means for determining that the STA is not associated with an AP, e.g., as described in connection with operation 804 in FIG. 8. In certain other configurations, the apparatus 1902/1902′ for wireless communication may include means for determining that the trigger frame allocates at least one RU for random access communications, e.g., as described in connection with operation 806 in FIG. 8. In certain other configurations, the apparatus 1902/1902′ for wireless communication may include means for identifying a reference channel indication, BSS color indication, or both from the trigger frame, e.g., as described in connection with operation 808 in FIG. 8. In certain other configurations, the apparatus 1902/1902′ for wireless communication may include means for communicating with the AP using the reference channel indication, the BSS color indicator, or both, e.g., as described in connection with operation 810 in FIG. 8. The aforementioned means may be the processor(s) 202, the radio, the MMU 240, the short-range communications controller 252, one or more of the aforementioned components of the apparatus 1902 and/or the processing system 2014 of the apparatus 1902′ configured to perform the functions recited by the aforementioned means.

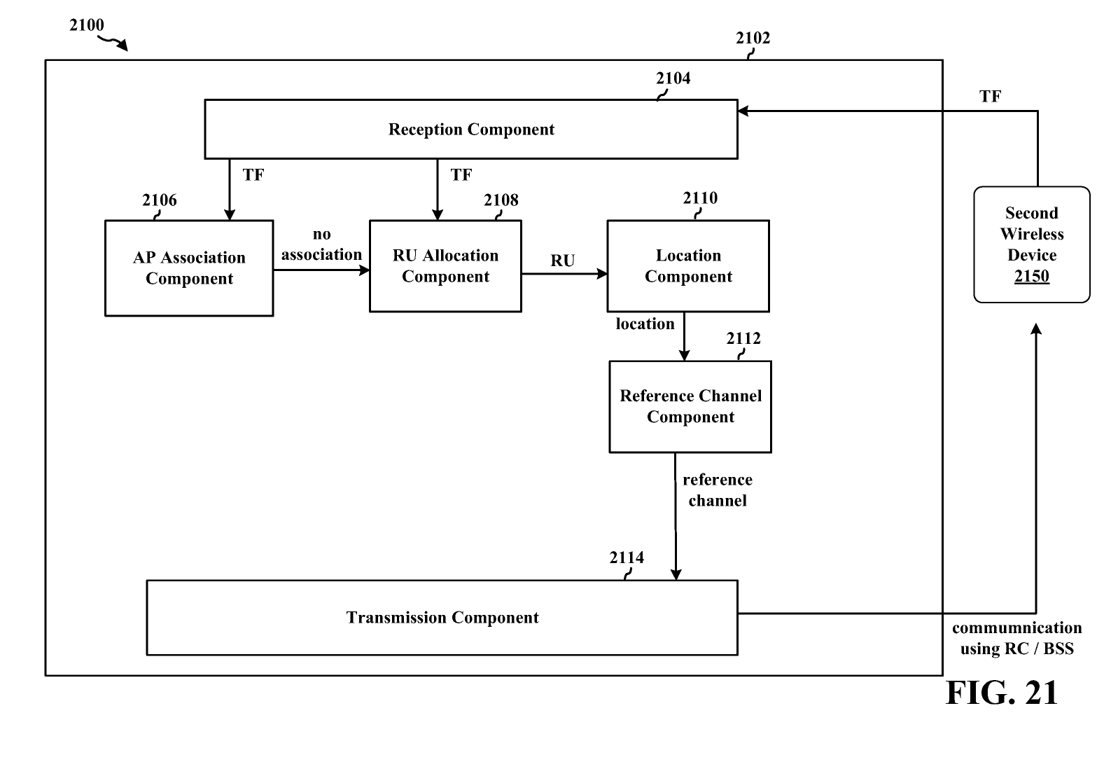

FIG. 21 is a conceptual data flow diagram 2100 illustrating the data flow between different means/components in an exemplary apparatus 2102. The apparatus 2102 may be a STA (when receiving the trigger frame from an AP or another STA) or an AP (when receiving the trigger frame from a STA or another AP). Note that for the remainder of the description of this data flow diagram, a STA (e.g., STA 115 of FIG. 4) will be described as the apparatus 2102 in communication with a second wireless device 2150 (e.g., AP STA 115 of FIG. 3), although the trigger frame may be received by an AP (e.g., AP 105 of FIG. 3) in other implementations. The apparatus 2102 may include a reception component 2104, an AP association component 2106, an RU allocation component 2108, a location component 2110, a reference channel component 2112, and a transmission component 2114.

The reception component 2104 may be configured to receive trigger frame from an AP (e.g., the second wireless device 2150), e.g., as described in connection with operation 902 in FIG. 9. The trigger frame may be sent to the AP association component 2106 and the RU allocation component 2108.

The AP association component 2106 may be configured to determine that the apparatus 2102 is not associated with the second wireless device 2150 (e.g., the AP), e.g., as described in connection with operation 904 in FIG. 9. Information indicating the apparatus 2102 is not associated with the second wireless device 2150.

The RU allocation component 2108 may be configured to determine that the trigger frame allocates an RU for random access communications, e.g., as described in connection with operation 908 in FIG. 9. Information indicating the RU allocation may be sent to the location component 2110.

The location component 2110 may be configured to determine a location of the STA, e.g., as described in connection with operation 910 in FIG. 9. Information indicating the location may be sent to the reference channel component 2112.

The reference channel component 2112 may be configured to identify a reference channel based on location of the apparatus 1902, e.g., as described in connection with operation 912 in FIG. 9. Information indicating the reference channel to the transmission component 914.

The transmission component 914 may be configured to communicate with the second wireless device 2150 using the reference channel, e.g., as described in connection with operation 914 in FIG. 9.

The apparatus may include additional components that perform each of the blocks of the algorithm in the aforementioned flowchart of FIG. 9. As such, each block in the aforementioned flowchart of FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

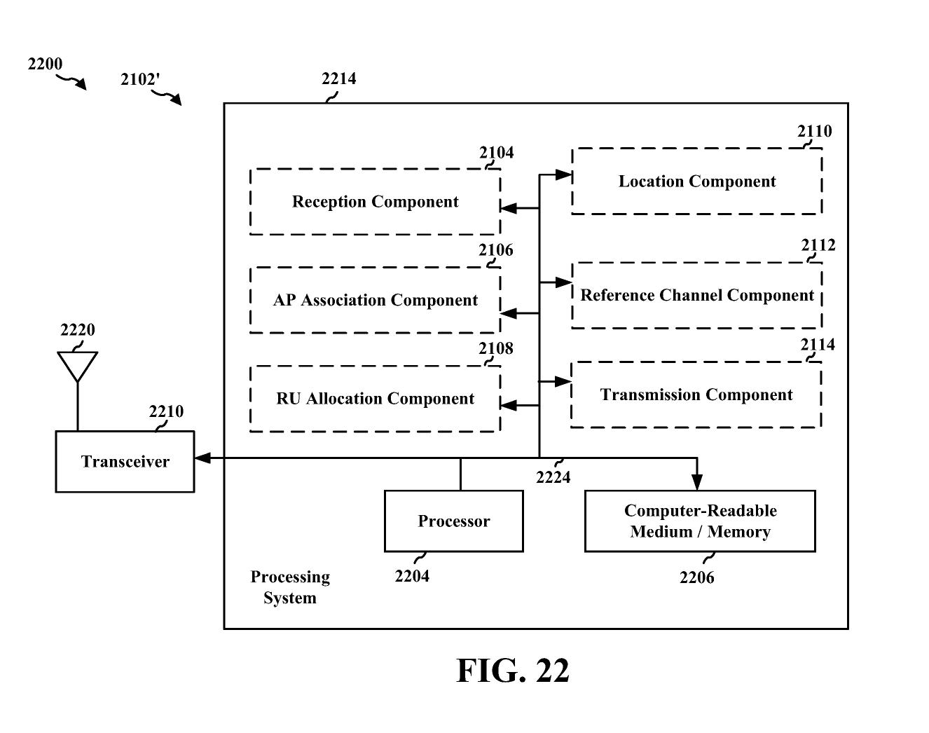

FIG. 22 is a diagram 2200 illustrating an example of a hardware implementation for an apparatus 2102′ employing a processing system 2214. The processing system 2214 may be implemented with a bus architecture, represented generally by the bus 2224. The bus 2224 may include any number of interconnecting buses and bridges depending on the specific application of the processing system 2214 and the overall design constraints. The bus 2224 links together various circuits including one or more processors and/or hardware components, represented by the processor 2204, the components 2104, 2106, 2108, 2110, 2112, 2114, and the computer-readable medium/memory 2206. The bus 2224 may also link various other circuits such as timing sources, peripherals, voltage regulators, and power management circuits, which are well known in the art, and therefore, will not be described any further.

The processing system 2214 may be coupled to a transceiver 2210. The transceiver 2210 is coupled to one or more antennas 2220. The transceiver 2210 provides a means for communicating with various other apparatus over a transmission medium. The transceiver 2210 receives a signal from the one or more antennas 2220, extracts information from the received signal, and provides the extracted information to the processing system 2214, specifically the reception component 2104. In addition, the transceiver 2210 receives information from the processing system 2214, specifically the transmission component 2114, and based on the received information, generates a signal to be applied to the one or more antennas 2220. The processing system 2214 includes a processor 2204 coupled to a computer-readable medium/memory 2206. The processor 2204 is responsible for general processing, including the execution of software stored on the computer-readable medium/memory 2206. The software, when executed by the processor 2204, causes the processing system 2214 to perform the various functions described supra for any particular apparatus. The computer-readable medium/memory 2206 may also be used for storing data that is manipulated by the processor 2204 when executing software. The processing system 2214 further includes at least one of the components 2104, 2106, 2108, 2110, 2112, 2114. The components may be software components running in the processor 2204, resident/stored in the computer readable medium/memory 2206, one or more hardware components coupled to the processor 2204, or some combination thereof.

In certain configurations, the apparatus 2102/2102′ for wireless communication may include means for receiving a trigger frame from an AP, e.g., as described in connection with operation 902 in FIG. 9. In certain other configurations, the apparatus 2102/2102′ for wireless communication may include means for determining that the STA is not associated with the AP, e.g., as described in connection with operation 904 in FIG. 9. In certain other configurations, the apparatus 2102/2102′ for wireless communication may include means for determining that the trigger frame allocates an RU for random access communications, e.g., as described in connection with operation 906 in FIG. 9. In certain other configurations, the apparatus 2102/2102′ for wireless communication may include means for determining a location of the STA, e.g., as described in connection with operation 908 in FIG. 9. In certain other configurations, the apparatus 2102/2102′ for wireless communication may include means for identifying reference channel based on the location of the STA, e.g., as described in connection with operation 910 in FIG. 9. In certain other configurations, the apparatus 2102/2102′ for wireless communication may include means for communicating with the AP using the reference channel, e.g., as described in connection with operation 912 in FIG. 9. The aforementioned means may be the processor(s) 202, the radio, the MMU 240, the short-range communications controller 252, one or more of the aforementioned components of the apparatus 2102 and/or the processing system 2214 of the apparatus 2102′ configured to perform the functions recited by the aforementioned means.

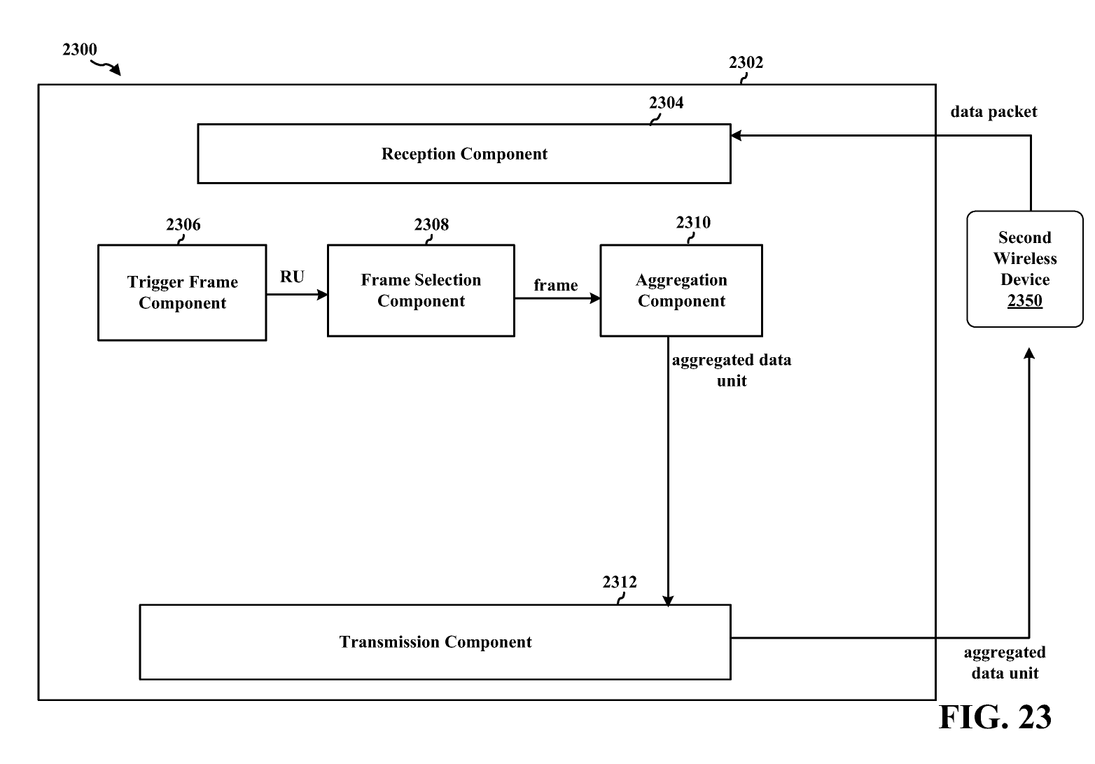

FIG. 23 is a conceptual data flow diagram 2300 illustrating the data flow between different means/components in an exemplary apparatus 2302. The apparatus 2302 may include an AP (for triggering a STA to generate a trigger-based response) or a STA (for triggering another STA to generate a trigger-based response) that generates a trigger frame. Note that for the remainder of the description of this data flow diagram, an AP (e.g., AP 105 of FIG. 3) will be described as the wireless communication device sending the trigger frame to the second wireless device 2350 (e.g., STA 115 in FIG. 4), although the trigger frame may be generated by a STA (e.g., STA 115 of FIG. 4) in other implementations. The apparatus 2302 may include a reception component 2304, a trigger frame component 2306, an aggregation component 2310, and a transmission component 2312.

The reception component 2304 may be configured to determine a trigger frame will allocate an RU for random access communications by unassociated STAs, e.g., as described in connection with operation 1002 in FIG. 10. Information indicating the RU may be sent to the frame selection component 2308.

The frame selection component 2308 may be configured to select a second frame that includes a reference channel indication, a BSS color indication, or both, e.g., as described in connection with operation 1004 in FIG. 10. Information associated with the second frame may be sent to the aggregation component 2310.

The aggregation component 2310 may be configured to aggregate the trigger frame with the second frame into an aggregated data unit, e.g., as described in connection with operation 1006 in FIG. 10. The aggregated data unit may be sent to the transmission component 2312.

The transmission component 2312 may be configured to output aggregated data unit for transmission to the second wireless device 2350 (e.g., STAs).

The apparatus may include additional components that perform each of the blocks of the algorithm in the aforementioned flowchart of FIG. 10. As such, each block in the aforementioned flowchart of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

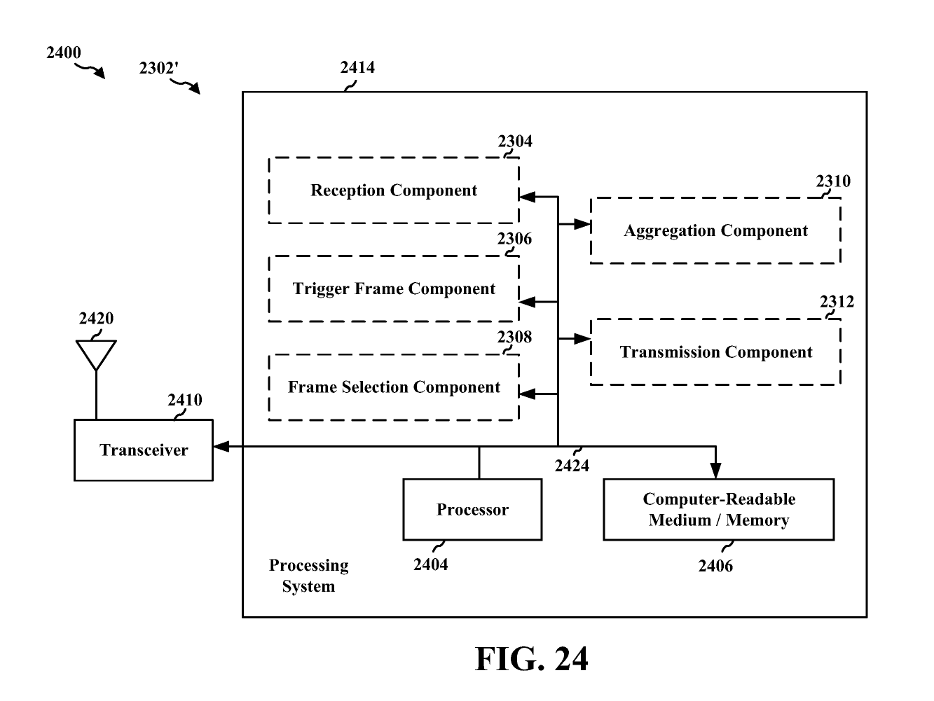

FIG. 24 is a diagram 2400 illustrating an example of a hardware implementation for an apparatus 2302′ employing a processing system 2414. The processing system 2414 may be implemented with a bus architecture, represented generally by the bus 2424. The bus 2424 may include any number of interconnecting buses and bridges depending on the specific application of the processing system 2414 and the overall design constraints. The bus 2424 links together various circuits including one or more processors and/or hardware components, represented by the processor 2404, the components 2304, 2306, 2308, 2310, 2312, and the computer-readable medium/memory 2406. The bus 2424 may also link various other circuits such as timing sources, peripherals, voltage regulators, and power management circuits, which are well known in the art, and therefore, will not be described any further.

The processing system 2414 may be coupled to a transceiver 2410. The transceiver 2410 is coupled to one or more antennas 2420. The transceiver 2410 provides a means for communicating with various other apparatus over a transmission medium. The transceiver 2410 receives a signal from the one or more antennas 2420, extracts information from the received signal, and provides the extracted information to the processing system 2414, specifically the reception component 2304. In addition, the transceiver 2410 receives information from the processing system 2414, specifically the transmission component 2312, and based on the received information, generates a signal to be applied to the one or more antennas 2420. The processing system 2414 includes a processor 2404 coupled to a computer-readable medium/memory 2406. The processor 2404 is responsible for general processing, including the execution of software stored on the computer-readable medium/memory 2406. The software, when executed by the processor 2404, causes the processing system 2414 to perform the various functions described supra for any particular apparatus. The computer-readable medium/memory 2406 may also be used for storing data that is manipulated by the processor 2404 when executing software. The processing system 2414 further includes at least one of the components 2304, 2306, 2308, 2310, 2312. The components may be software components running in the processor 2404, resident/stored in the computer readable medium/memory 2406, one or more hardware components coupled to the processor 2404, or some combination thereof.

In certain configurations, the apparatus 2302/2302′ for wireless communication may include means for determining trigger frame will allocate an RU for random access communications by unassociated STAs, e.g., as described in connection with operation 1002 in FIG. 10. In certain other configurations, the apparatus 2302/2302′ for wireless communication may include means for selecting a second frame that includes a reference channel indication, a BSS color indication, or both, e.g., as described in connection with operation 1004 in FIG. 10. In certain other configurations, the apparatus 2302/2302′ for wireless communication may include means for aggregating the trigger frame with the second frame into an aggregated data unit, e.g., as described in connection with operation 1006 in FIG. 10. In certain other configurations, the apparatus 2302/2302′ for wireless communication may include means for output aggregated data unit for transmission to STAs, e.g., as described in connection with operation 1008 in FIG. 10. The aforementioned means may be the processor(s) 202, the radio, the MMU 240, the short-range communications controller 252, one or more of the aforementioned components of the apparatus 2302 and/or the processing system 2414 of the apparatus 2302′ configured to perform the functions recited by the aforementioned means.

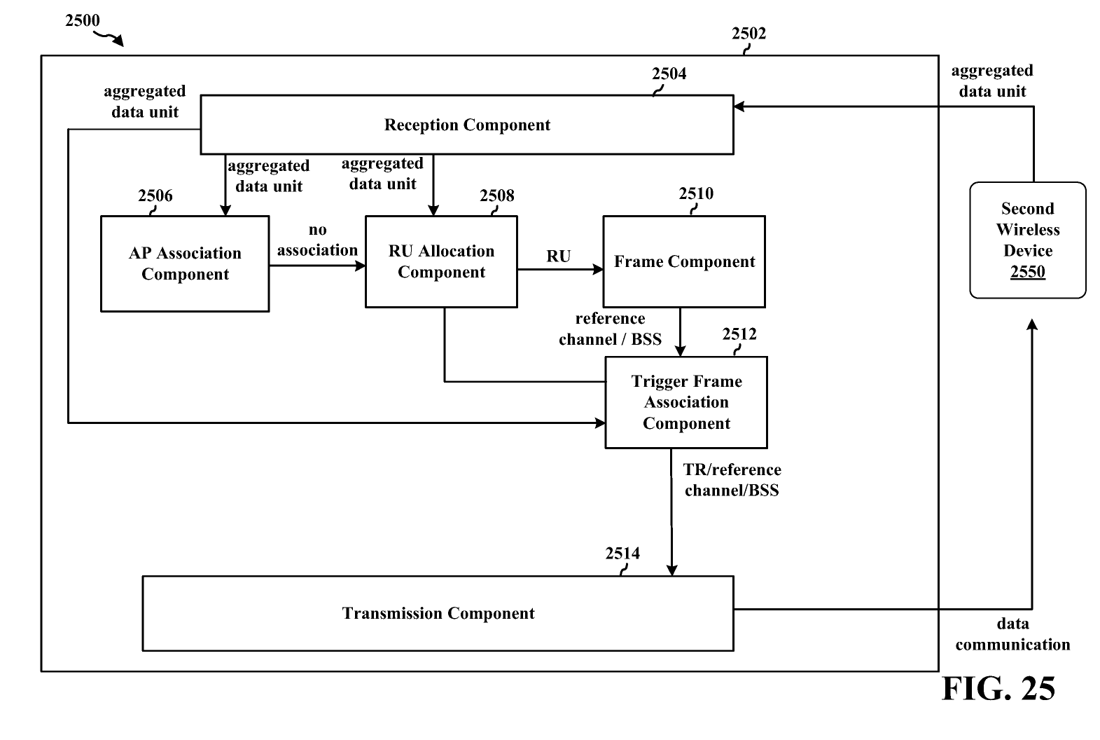

FIG. 25 is a conceptual data flow diagram 2500 illustrating the data flow between different means/components in an exemplary apparatus 2502. The apparatus 2502 may receive an aggregated data unit from a second wireless device 2550 and determine a reference channel or BSS color indication used by the second device to assist the wireless communication device to respond to a trigger frame included in the aggregated data unit. The apparatus 2502 may be a STA (when receiving the trigger frame from an AP or another STA) or an AP (when receiving the trigger frame from a STA or another AP). Note that for the remainder of the description of this flow diagram, a STA (e.g., STA 115 of FIG. 4) will be described as the apparatus 2502 receiving and processing the trigger frame received from the second wireless device 2550 (e.g., the AP 105 of FIG. 4), although the trigger frame may be received by an AP (e.g., AP 105 of FIG. 3) in other implementations. The apparatus 2502 may include a reception component 2504, an AP association component 2506, an RU allocation component 2508, a frame component 2510, a trigger frame association component 2512, and a transmission component 2514.

The reception component 2504 may be configured to receive an aggregated data unit from the second wireless device 2550, e.g., as described in connection with operation 1102 in FIG. 11. The aggregated data unit may be sent to the AP association component 2506, the RU allocation component 2408, and the trigger frame association component 2512.

The AP association component 2506 may be configured to determine that STA is not associated with the second wireless device 2550, e.g., as described in connection with operation 1104 in FIG. 11. Information indicating that the apparatus 2502 is not associated with the second wireless device 2550 to the RU allocation component 2508.

The RU allocation component 2508 may be configured to determine that the aggregated data unit includes a trigger frame that allocates an RU for random access communications, e.g., as described in connection with operation 1106 in FIG. 11. Information indicating that the trigger frame allocates the RU to the frame component 2510.

The frame component 2510 may be configured to identify a second frame in the aggregated data unit that includes a reference channel indication, a BSS color indication, or both, e.g., as described in connection with operation 1108 in FIG. 11. The second frame and information indicating the reference channel indication, the BSS color indication, or both to the trigger frame association component 2512.

The trigger frame association component 2512 may be configured to associate the reference channel indication, BSS color indication, or both with information from the trigger frame, e.g., as described in connection with operation 1110 in FIG. 11. The trigger frame including the association of the reference channel indication, the BSS color indication, or both may be sent to the transmission component 2514.

The transmission component 2514 may be configured to communicate with the second wireless device 2550 using the reference channel indication, the BS color indicator, or both, e.g., as described in connection with operation 1112 in FIG. 11.

The apparatus may include additional components that perform each of the blocks of the algorithm in the aforementioned flowchart of FIG. 11. As such, each block in the aforementioned flowchart of FIG. 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

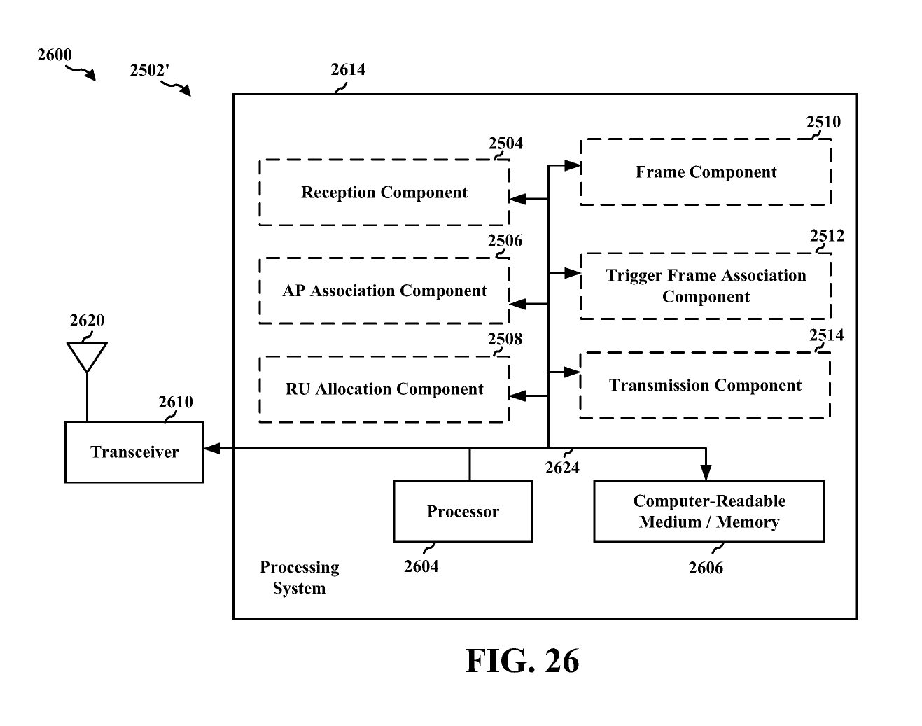

FIG. 26 is a diagram 2600 illustrating an example of a hardware implementation for an apparatus 2502′ employing a processing system 2614. The processing system 2614 may be implemented with a bus architecture, represented generally by the bus 2624. The bus 2624 may include any number of interconnecting buses and bridges depending on the specific application of the processing system 2614 and the overall design constraints. The bus 2624 links together various circuits including one or more processors and/or hardware components, represented by the processor 2604, the components 2504, 2506, 2508, 2510, 2512 and the computer-readable medium/memory 2606. The bus 2624 may also link various other circuits such as timing sources, peripherals, voltage regulators, and power management circuits, which are well known in the art, and therefore, will not be described any further.

The processing system 2614 may be coupled to a transceiver 2610. The transceiver 2610 is coupled to one or more antennas 2620. The transceiver 2610 provides a means for communicating with various other apparatus over a transmission medium. The transceiver 2610 receives a signal from the one or more antennas 2620, extracts information from the received signal, and provides the extracted information to the processing system 2614, specifically the reception component 2504. In addition, the transceiver 2610 receives information from the processing system 2614, specifically the transmission component 2514, and based on the received information, generates a signal to be applied to the one or more antennas 2620. The processing system 2614 includes a processor 2604 coupled to a computer-readable medium/memory 2606. The processor 2604 is responsible for general processing, including the execution of software stored on the computer-readable medium/memory 2606. The software, when executed by the processor 2604, causes the processing system 2614 to perform the various functions described supra for any particular apparatus. The computer-readable medium/memory 2606 may also be used for storing data that is manipulated by the processor 2604 when executing software. The processing system 2614 further includes at least one of the components 2504, 2506, 2508, 2510, 2512. The components may be software components running in the processor 2604, resident/stored in the computer readable medium/memory 2606, one or more hardware components coupled to the processor 2604, or some combination thereof.

In certain configurations, the apparatus 2502/2502′ for wireless communication may include means for receiving aggregated data unit from AP, e.g., as described in connection with operation 1102 in FIG. 12. In certain other configurations, the apparatus 2502/2502′ for wireless communication may include means for determining that the STA is not associated with an AP, e.g., as described in connection with operation 1104 in FIG. 12. In certain other configurations, the apparatus 2502/2502′ for wireless communication may include means for determining that the aggregated data unit includes a trigger frame that allocates RU for random access communications, e.g., as described in connection with operation 1106 in FIG. 12. In certain other configurations, the apparatus 2502/2502′ for wireless communication may include means for identifying a second frame in the aggregated data unit that includes a reference channel indication, a BSS color indication, or both, e.g., as described in connection with operation 1108 in FIG. 12. In certain other configurations, the apparatus 2502/2502′ for wireless communication may include means for associating the reference channel indication, BSS color indication, or both with information from the trigger frame, e.g., as described in connection with operation 1110 in FIG. 12. In certain other configurations, the apparatus 2502/2502′ for wireless communication may include means for communicating with the AP using the reference channel indication, the BSS color indicator, or both, e.g., as described in connection with operation 1112 in FIG. 12. The aforementioned means may be the processor(s) 202, the radio, the MMU 240, short-range communications controller 252, one or more of the aforementioned components of the apparatus 2502 and/or the processing system 2614 of the apparatus 2502′ configured to perform the functions recited by the aforementioned means.

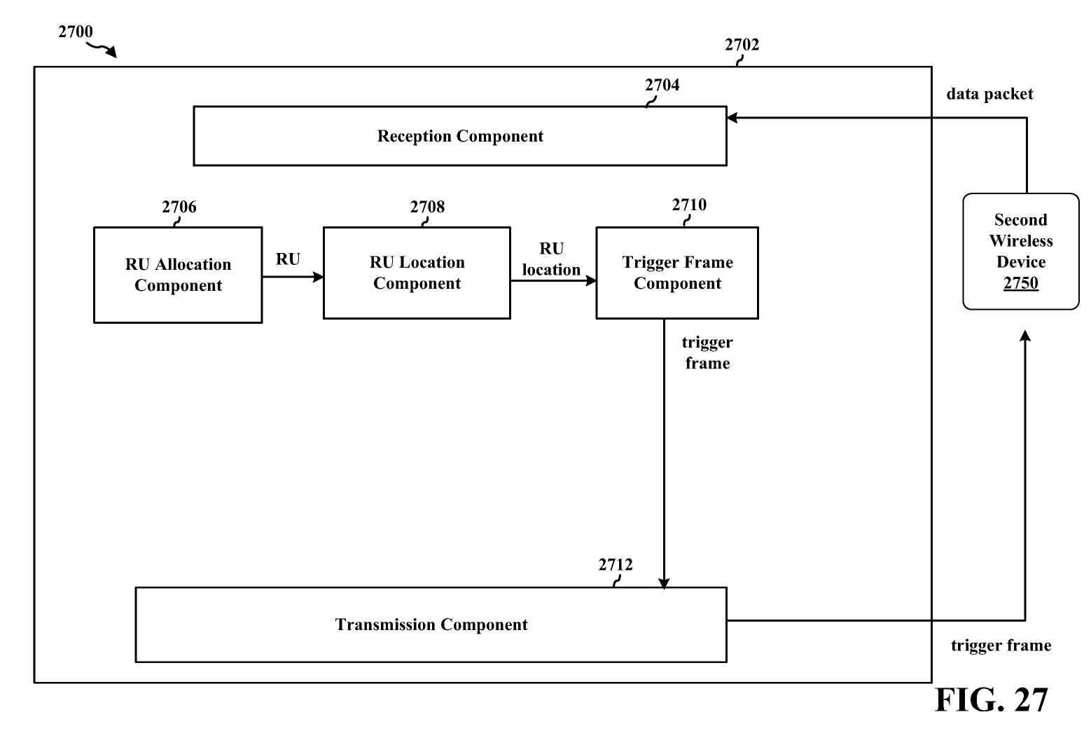

FIG. 27 is a conceptual data flow diagram 2700 illustrating the data flow between different means/components in an exemplary apparatus 2702. The apparatus 2702 may include an AP (for triggering a STA to generate a trigger-based response) or a STA (for triggering another STA to generate a trigger-based response) generates a trigger frame. Note that for the remainder of the description of this flow diagram, an AP (e.g., AP 105 of FIG. 3) will be described as the wireless communication device sending the trigger frame to a second wireless device 2750 (e.g., STA 115 of FIG. 3), although the trigger frame may be generated by a STA (e.g., STA 115 of FIG. 4) in other implementations. The apparatus 2702 may include a reception component 2704, an RU allocation component 2706, an RU location component 2708, a trigger frame component 2710, and transmission component 2712.

The RU allocation component 2706 may be configured to determine an RU will be allocated for random access communication by an unassociated STA, e.g., as described in connection with operation 1202 in FIG. 12. Information associated with the RU may be sent to the RU location component 2708.

The RU location component 2708 may be configured to choose location for the allocated RU to be located within a bandwidth that corresponds to reference channel of the apparatus 2702, e.g., as described in connection with operation 1204 in FIG. 12. Information associated with the RU location may be sent to a trigger frame component 2710. The trigger frame component 2710 may be configured to generate a trigger frame that indicates the location for the allocated RU that is sent to the transmission component 2712.

The transmission component 2712 may be configured to generate and output trigger frame to signal the RU allocation and/or reference channel, e.g., as described in connection with operation 1206 in FIG. 12.

The apparatus may include additional components that perform each of the blocks of the algorithm in the aforementioned flowchart of FIG. 12. As such, each block in the aforementioned flowchart of FIG. 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

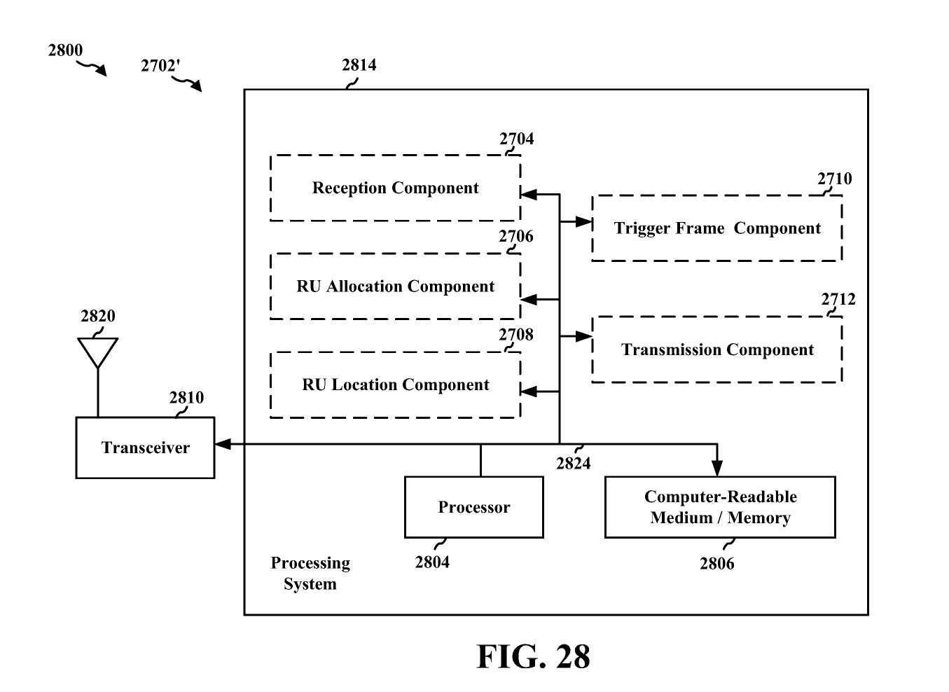

FIG. 28 is a diagram 2800 illustrating an example of a hardware implementation for an apparatus 2702′ employing a processing system 2814. The processing system 2814 may be implemented with a bus architecture, represented generally by the bus 2824. The bus 2824 may include any number of interconnecting buses and bridges depending on the specific application of the processing system 2814 and the overall design constraints. The bus 2824 links together various circuits including one or more processors and/or hardware components, represented by the processor 2804, the components 2704, 2706, 2708, 2710, 2712, and the computer-readable medium/memory 2806. The bus 2824 may also link various other circuits such as timing sources, peripherals, voltage regulators, and power management circuits, which are well known in the art, and therefore, will not be described any further.

The processing system 2814 may be coupled to a transceiver 2810. The transceiver 2810 is coupled to one or more antennas 2820. The transceiver 2810 provides a means for communicating with various other apparatus over a transmission medium. The transceiver 2810 receives a signal from the one or more antennas 2820, extracts information from the received signal, and provides the extracted information to the processing system 2814, specifically the reception component 2704. In addition, the transceiver 2810 receives information from the processing system 2814, specifically the transmission component 2712, and based on the received information, generates a signal to be applied to the one or more antennas 2820. The processing system 2814 includes a processor 2804 coupled to a computer-readable medium/memory 2806. The processor 2804 is responsible for general processing, including the execution of software stored on the computer-readable medium/memory 2806. The software, when executed by the processor 2804, causes the processing system 2814 to perform the various functions described supra for any particular apparatus. The computer-readable medium/memory 2806 may also be used for storing data that is manipulated by the processor 2804 when executing software. The processing system 2814 further includes at least one of the components 2704, 2706, 2708, 2710, 2712. The components may be software components running in the processor 2804, resident/stored in the computer readable medium/memory 2806, one or more hardware components coupled to the processor 2804, or some combination thereof.

In certain configurations, the apparatus 2702/2702′ for wireless communication may include means for determining RU will be allocated for random access communication by unassociated STA, e.g., as described in connection with operation 1202 in FIG. 12. In certain other configurations, the apparatus 2702/2702′ for wireless communication may include means for choosing location for allocated RU to be located within a bandwidth that corresponds to reference channel of AP, e.g., as described in connection with operation 1204 in FIG. 12. In certain other configurations, the apparatus 2702/2702′ for wireless communication may include means for generating and outputting trigger frame to signal the RU allocation and/or reference channel, e.g., as described in connection with operation 1206 in FIG. 12. The aforementioned means may be the processor(s) 202, the radio, the MMU 240, short-range communications controller 252, one or more of the aforementioned components of the apparatus 2702 and/or the processing system 2814 of the apparatus 2702′ configured to perform the functions recited by the aforementioned means.

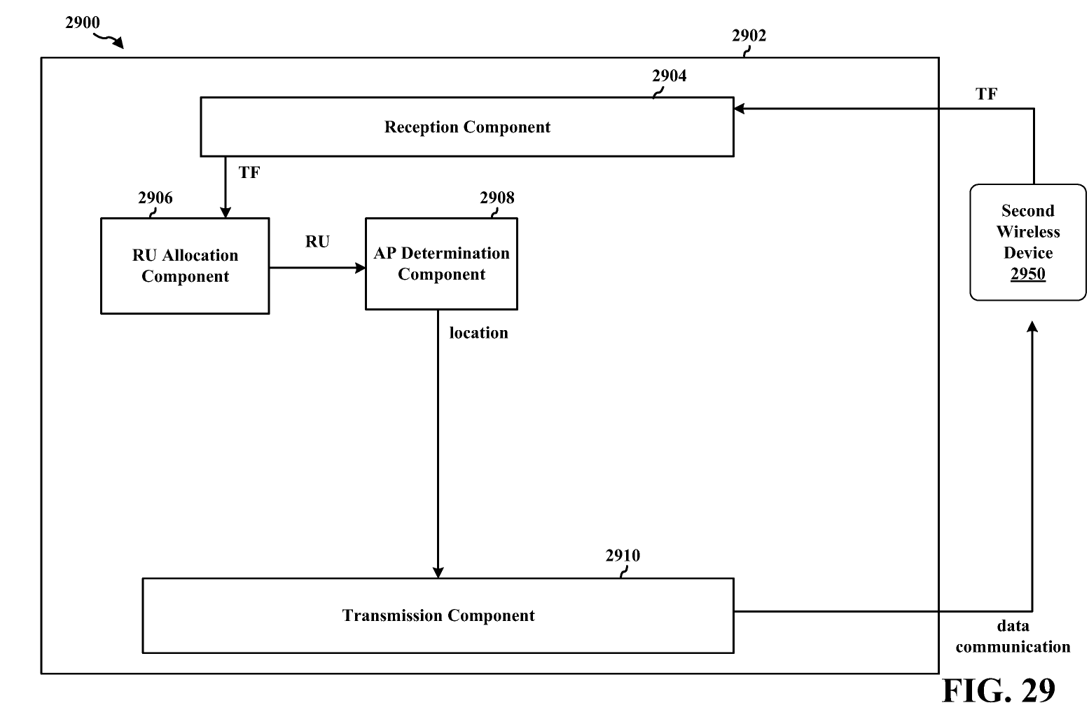

FIG. 29 is a conceptual data flow diagram 2900 illustrating the data flow between different means/components in an exemplary apparatus 2902. The apparatus 2902 may receive a trigger frame from a second device and determine the primary reference channel used by the second device to assist the wireless communication device to respond to the trigger frame. The apparatus 2902 may be a STA (when receiving the trigger frame from an AP or another STA) or an AP (when receiving the trigger frame from a STA or another AP). Note that for the remainder of the description of this data flow diagram, a STA (e.g., STA 115 of FIG. 4) will be described as the apparatus 2902 receiving and processing the trigger frame received from the second wireless device 2950 (e.g., the AP 105 of FIG. 4), although the trigger frame may be received by an AP (e.g., AP 105 of FIG. 3) in other implementations. The apparatus 2902 may include a reception component 2904, an RU allocation component 2906, an AP determination component 2908, and a transmission component 2910.

The reception component 2904 may be configured to receive trigger frame from an AP, e.g., as described in connection with operation 1302 in FIG. 13. The trigger frame may be sent to the RU allocation component 2906.

The RU allocation component 2906 may be configured to determine that the trigger frame allocates RU for random access communications, e.g., as described in connection with operation 1304 in FIG. 13. Information associated with the RU may be sent to the AP determination component 2908.

The AP determination component 2908 may be configured to determine a location of RU and identify the AP's reference channel based on location of the RU, e.g., as described in connection with operation 1306 in FIG. 13. Information associated with the RU and AP's reference channel may be sent to the transmission component 2910.

The transmission component 2910 may be configured to communicate with the second wireless device 2950.

The apparatus may include additional components that perform each of the blocks of the algorithm in the aforementioned flowchart of FIG. 29. As such, each block in the aforementioned flowchart of FIG. 29 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

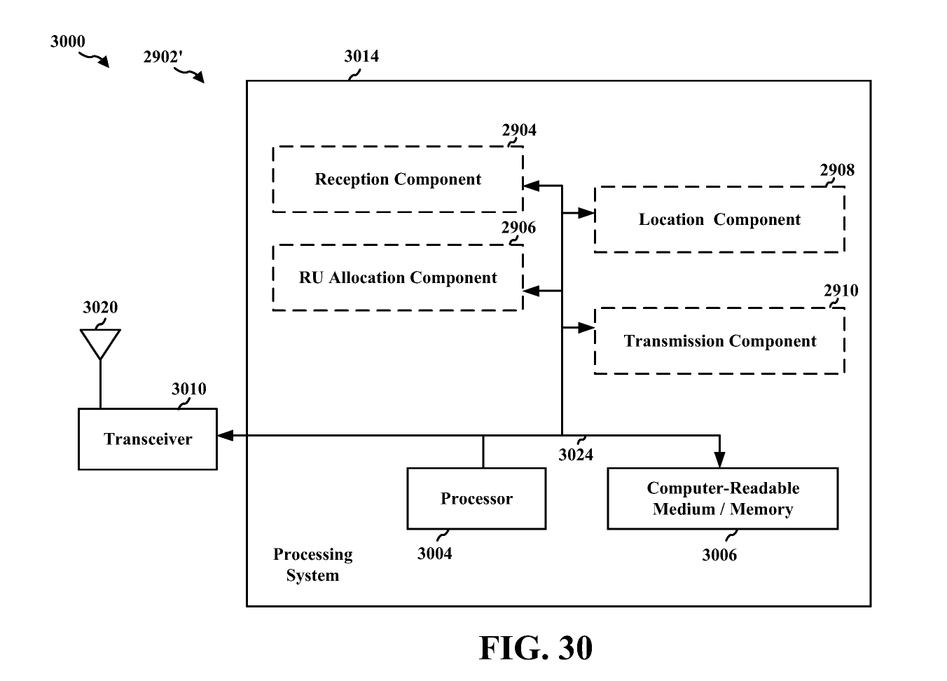

FIG. 30 is a diagram 3000 illustrating an example of a hardware implementation for an apparatus 2902′ employing a processing system 3014. The processing system 3014 may be implemented with a bus architecture, represented generally by the bus 3024. The bus 3024 may include any number of interconnecting buses and bridges depending on the specific application of the processing system 3014 and the overall design constraints. The bus 3024 links together various circuits including one or more processors and/or hardware components, represented by the processor 3004, the components 2904, 2906, 2908, 2910 and the computer-readable medium/memory 3006. The bus 3024 may also link various other circuits such as timing sources, peripherals, voltage regulators, and power management circuits, which are well known in the art, and therefore, will not be described any further.

The processing system 3014 may be coupled to a transceiver 3010. The transceiver 3010 is coupled to one or more antennas 3020. The transceiver 3010 provides a means for communicating with various other apparatus over a transmission medium. The transceiver 3010 receives a signal from the one or more antennas 3020, extracts information from the received signal, and provides the extracted information to the processing system 3014, specifically the reception component 2904. In addition, the transceiver 3010 receives information from the processing system 3014, specifically the transmission component 2910, and based on the received information, generates a signal to be applied to the one or more antennas 3020. The processing system 3014 includes a processor 3004 coupled to a computer-readable medium/memory 3006. The processor 3004 is responsible for general processing, including the execution of software stored on the computer-readable medium/memory 3006. The software, when executed by the processor 3004, causes the processing system 3014 to perform the various functions described supra for any particular apparatus. The computer-readable medium/memory 3006 may also be used for storing data that is manipulated by the processor 3004 when executing software. The processing system 3014 further includes at least one of the components 2904, 2906, 2908, 2910. The components may be software components running in the processor 3004, resident/stored in the computer readable medium/memory 3006, one or more hardware components coupled to the processor 3004, or some combination thereof.

In certain configurations, the apparatus 2902/2902′ for wireless communication may include means for receiving trigger frame from an AP, e.g., as described in connection with operation 1302 in FIG. 13. In certain other configurations, the apparatus 2902/2902′ for wireless communication may include means for determining that the trigger frame allocates RU for random access communications, e.g., as described in connection with operation 1304 in FIG. 13. In certain other configurations, the apparatus 2902/2902′ for wireless communication may include means for determining location of RU and identify AP's reference channel based on location, e.g., as described in connection with operation 1306 in FIG. 13. The aforementioned means may be the processor(s) 202, the radio, the MMU 240, the short-range communications controller 252, one or more of the aforementioned components of the apparatus 2902 and/or the processing system 3014 of the apparatus 2902′ configured to perform the functions recited by the aforementioned means.

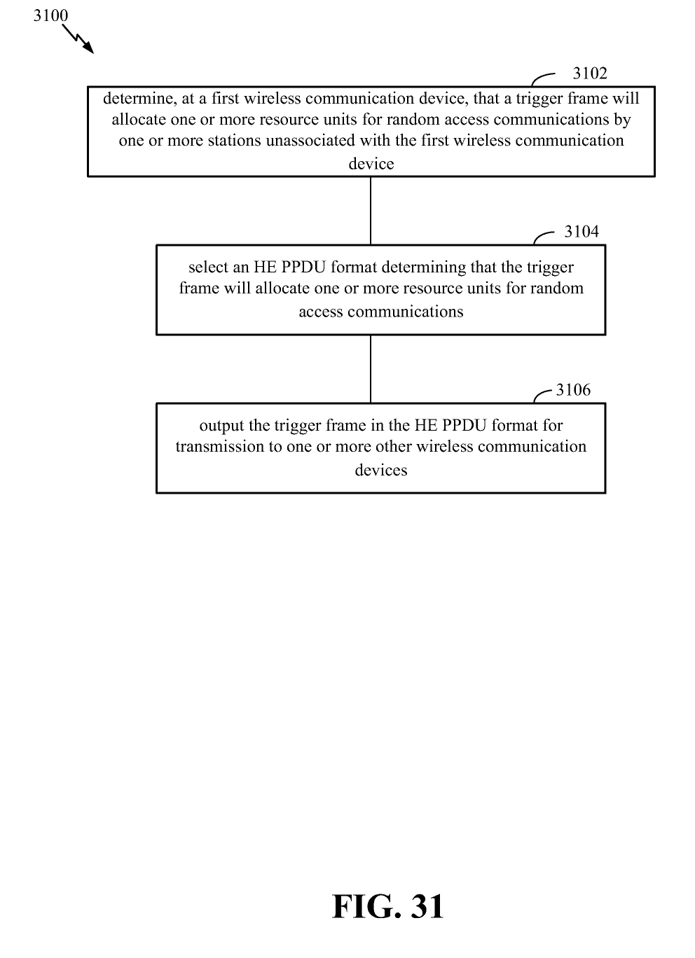

FIG. 31 is a flow diagram illustrating an example of a process 3100 for selecting an HE-PPDU when at least an RU is allocated for random access communications and adding a BSS color indication to a trigger frame, in accordance with various aspects of the present disclosure. In process 3100, a wireless communication device, such as an AP (for triggering a STA to generate a trigger-based response) or a STA (for triggering another STA to generate a trigger-based response) generates a trigger frame. Note that for the remainder of the description of this flow diagram, an AP (e.g., AP 105 of FIG. 3) will be described as the wireless communication device sending the trigger frame, although the trigger frame may be generated by a STA (e.g., STA 115 of FIG. 4) in other implementations.

At block 3102, the first wireless communication device may determine, at a first wireless communication device, that a trigger frame will allocate one or more resource units for random access communications by one or more stations unassociated with the first wireless communication device. Random access communications in one implementation differ from directed communications in that any STA within a designated category (e.g., all associated STAs or all unassociated STAs) may access an allocated RU in random access communication mode as opposed to only a specific STA directed by the AP to use the RU in directed communication mode. When an RU is allocated for random access communications by unassociated STAs, any unassociated STA may contend for the allocated RU. The AP may customize the fields of the trigger frame to indicate that it allocates one or more RUs for random access communications by one or more STAs that are currently unassociated with the AP. In one implementation, the AP may signal the random access RU allocation in a user information field of the trigger frame (e.g., user information field 212 of trigger frame 200 of FIG. 2). FIG. 6 shows one example of a user information field 600, such as one of user information fields 212, 214, or 216 (see FIG. 2). The user information field 600 includes an AID12 subfield 602, an RU allocation subfield 604, a coding type subfield 606, a modulation coding scheme (MCS) subfield 608, a dual carrier modulation (DCM) subfield 610, a spatial stream (SS) allocation subfield 612, a target received signal strength indicator (RSSI) subfield 614, a reserved subfield 616, and a trigger dependent user information subfield 618.

At block 3104, the first wireless communication device may select a high-efficiency (HE) Physical Layer Convergence Procedure (PLCP) protocol data unit (PPDU) format for the trigger frame upon determining that the trigger frame will allocate one or more resource units for random access communications. In certain aspects, a basic service set (BSS) color indication associated with the first wireless communication device may be included in a header of the HE PPDU format. The AP may set a rule that it will always send trigger frames that include RUs allocated for random access communications by unassociated STAs in a PPDU formatted according to IEEE 802.11ax or future formats. 11ax PPDUs (e.g., high efficiency (HE) PPDUs) will indicate the BSS color indicator to receiving stations regardless of what frames are included in the PPDU. In this implementation, the AP may determine that it is going to send a trigger frame with an RU allocated for random access communications by unassociated STAs. In response to this determination, the AP may ensure that it does not use a legacy (e.g., pre-11ax) PPDU format to send the trigger frame that includes an RU allocated for random access communications by unassociated STAs.

At 3110, the AP may output the trigger frame in HE PPDU format for transmission to the one or more other wireless communication devices. In one implementation, a microchip or integrated circuit (e.g., a modem chip) that is a sub-component of the AP may output the trigger frame for eventual physical transmission over the air through other sub-components of the AP, such as a radio frequency transmitter and an antenna of the AP (and other radio frequency transmission components of the AP). In another implementation, the AP itself as an entire unit outputs the trigger frame for transmission by formatting the message data and generating the physical over-the-air transmission of the data of the trigger frame to be received by one or more STAs.

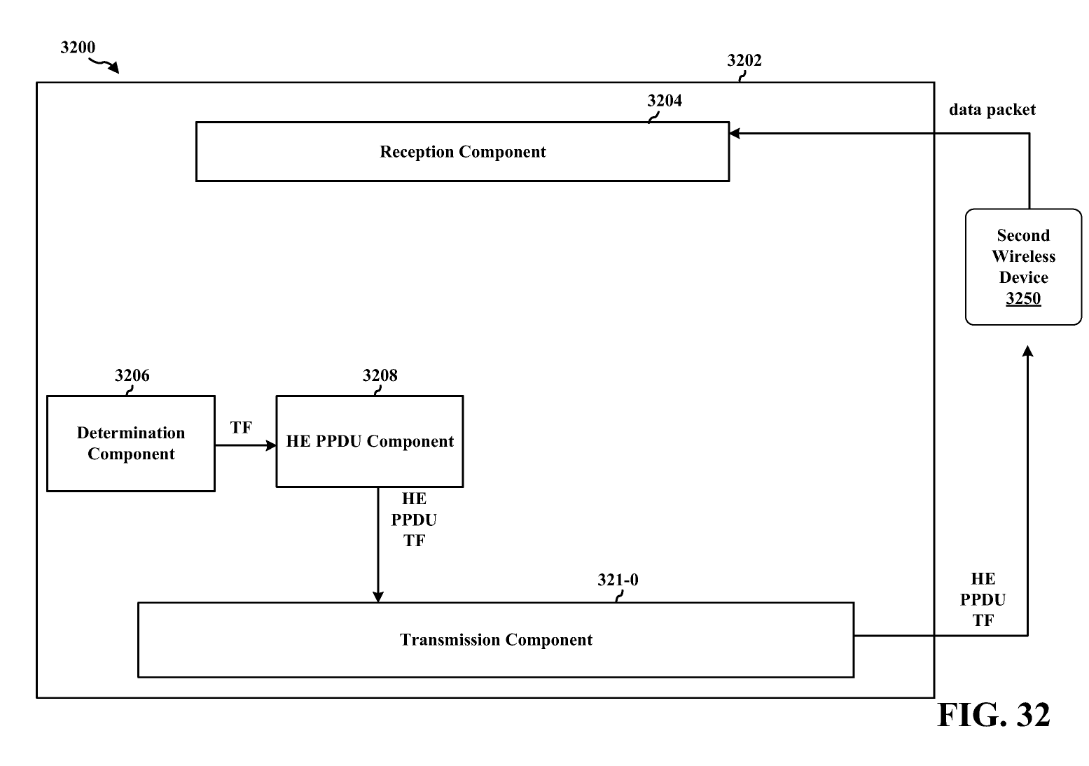

FIG. 32 is a conceptual data flow diagram 3200 illustrating the data flow between different means/components in an exemplary apparatus 3202. The apparatus 3202 may include an AP (for triggering a STA to generate a trigger-based response) or a STA (for triggering another STA to generate a trigger-based response) generates a trigger frame. Note that for the remainder of the description of this flow diagram, an AP (e.g., AP 105 of FIG. 3) will be described as the wireless communication device sending the trigger frame to a second wireless device 2750 (e.g., STA 115 of FIG. 3), although the trigger frame may be generated by a STA (e.g., STA 115 of FIG. 4) in other implementations. The apparatus 3202 may include a reception component 3204, a determination component 3206, an HE PPDU component 3208, and a transmission component 3210.

The determination component 3206 may be configured to determine, at a first wireless communication device, that a trigger frame will allocate one or more resource units for random access communications by one or more other wireless communication devices (e.g., second wireless device 3250) unassociated with the first wireless communication device. The determination component 3206 may be configured to send information associated with the trigger frame/resource units to the HE PPDU component 3208.

The HE PPDU component 3208 may be configured select a high-efficiency (HE) Physical Layer Convergence Procedure (PLCP) protocol data unit (PPDU) format for the trigger frame upon determining that the trigger frame will allocate one or more resource units for random access communications. In certain aspects, a basic service set (BSS) color indication associated with the first wireless communication device may be included in a header of the HE PPDU format. The HE PPDU component 3208 may be configured to send information associated with the HE PPDU to the transmission component 3210.

The transmission component 3214 may be configured to output the trigger frame in HE PPDU format for transmission to the one or more other wireless communication devices (e.g., second wireless device 3250).

The reception component 3204 may be configured to receive one or more data packets from the second wireless device

The apparatus may include additional components that perform each of the blocks of the algorithm in the aforementioned flowchart of FIG. 31. As such, each block in the aforementioned flowchart of FIG. 31 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

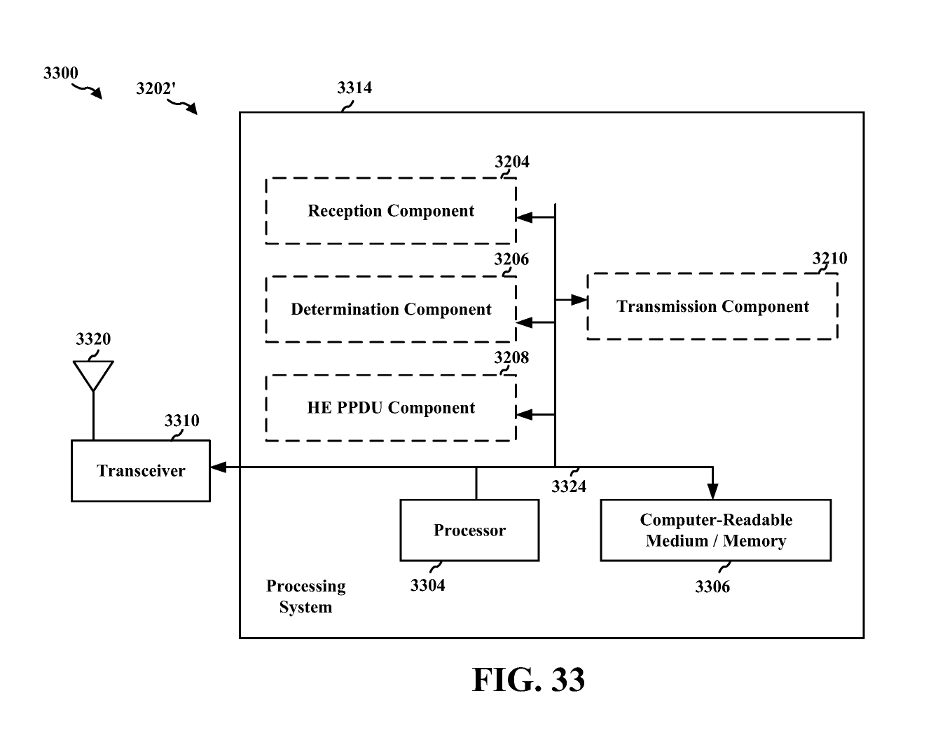

FIG. 33 is a diagram 3300 illustrating an example of a hardware implementation for an apparatus 3202′ employing a processing system 3314. The processing system 3314 may be implemented with a bus architecture, represented generally by the bus 3324. The bus 3324 may include any number of interconnecting buses and bridges depending on the specific application of the processing system 3314 and the overall design constraints. The bus 3324 links together various circuits including one or more processors and/or hardware components, represented by the processor 3304, the components 3204, 3206, 3208, 3210, and the computer-readable medium/memory 3306. The bus 3324 may also link various other circuits such as timing sources, peripherals, voltage regulators, and power management circuits, which are well known in the art, and therefore, will not be described any further.

The processing system 3314 may be coupled to a transceiver 3310. The transceiver 3310 is coupled to one or more antennas 3320. The transceiver 3310 provides a means for communicating with various other apparatus over a transmission medium. The transceiver 3310 receives a signal from the one or more antennas 3320, extracts information from the received signal, and provides the extracted information to the processing system 3314, specifically the reception component 3204. In addition, the transceiver 3310 receives information from the processing system 3314, specifically the transmission component 3210, and based on the received information, generates a signal to be applied to the one or more antennas 3320. The processing system 3314 includes a processor 3304 coupled to a computer-readable medium/memory 3306. The processor 3304 is responsible for general processing, including the execution of software stored on the computer-readable medium/memory 3306. The software, when executed by the processor 3304, causes the processing system 3314 to perform the various functions described supra for any particular apparatus. The computer-readable medium/memory 3306 may also be used for storing data that is manipulated by the processor 3304 when executing software. The processing system 3314 further includes at least one of the components 3204, 3206, 3208, 3210. The components may be software components running in the processor 3304, resident/stored in the computer readable medium/memory 3306, one or more hardware components coupled to the processor 3304, or some combination thereof. The processing system 3314 may be a component of the base station 310 and may include the memory 376 and/or at least one of the TX processor 316, the RX processor 370, and the controller/processor 375.

In certain configurations, the apparatus 3202/3202′ for wireless communication includes means for determining, at a first wireless communication device, that a trigger frame will allocate one or more resource units for random access communications by one or more other wireless communication devices unassociated with the first wireless communication device. In certain other configurations, the apparatus 3202/3202′ for wireless communication includes means for selecting a high-efficiency (HE) Physical Layer Convergence Procedure (PLCP) protocol data unit (PPDU) format for the trigger frame upon determining that the trigger frame will allocate one or more resource units for random access communications. In certain aspects, a basic service set (BSS) color indication associated with the first wireless communication device may be included in a header of the HE PPDU format. In certain other configurations, the apparatus 3202/3202′ for wireless communication includes means for select a high-efficiency (HE) Physical Layer Convergence Procedure (PLCP) protocol data unit (PPDU) format for the trigger frame upon determining that the trigger frame will allocate one or more resource units for random access communications. In certain aspects, a basic service set (BSS) color indication associated with the first wireless communication device may be included in a header of the HE PPDU format. In certain other configurations, the apparatus 3202/3202′ for wireless communication includes means for outputting the trigger frame in HE PPDU format for transmission to the one or more other wireless communication devices. The aforementioned means may be one or more of the aforementioned components of the apparatus 3202 and/or the processing system 3314 of the apparatus 3202′ configured to perform the functions recited by the aforementioned means. As described supra, the processing system 3314 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

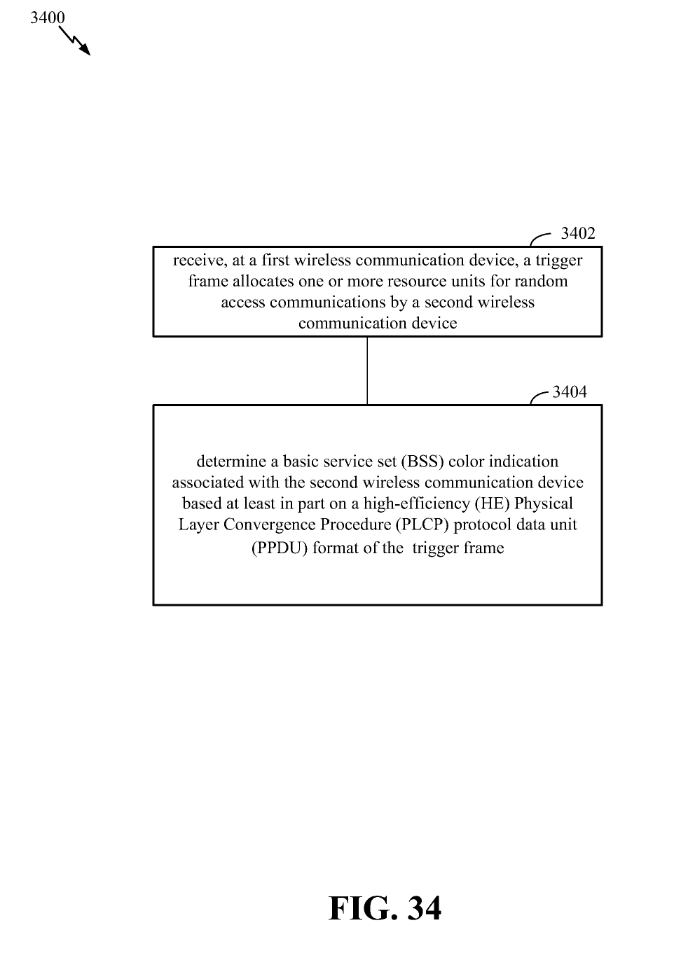

FIG. 34 is a flow diagram illustrating an example of a process 3400 for receiving an HE-PPDU when at least an RU is allocated for random access communications and determining a BSS color indication associated with an AP a trigger frame, in accordance with various aspects of the present disclosure. In process 3500, a wireless communication device, such as an STA or an AP.

At block 3402, the first wireless communication device may receiving, at a first wireless communication device, a trigger frame allocates one or more resource units for random access communications by a second wireless communication device. In certain aspects, the first wireless device may be unassociated with the second wireless communication device. Random access communications in one implementation differ from directed communications in that any STA within a designated category (e.g., all associated STAs or all unassociated STAs) may access an allocated RU in random access communication mode as opposed to only a specific STA directed by the AP to use the RU in directed communication mode. When an RU is allocated for random access communications by unassociated STAs, any unassociated STA may contend for the allocated RU. The AP may customize the fields of the trigger frame to indicate that it allocates one or more RUs for random access communications by one or more STAs that are currently unassociated with the AP. In one implementation, the AP may signal the random access RU allocation in a user information field of the trigger frame (e.g., user information field 212 of trigger frame 200 of FIG. 2). FIG. 6 shows one example of a user information field 600, such as one of user information fields 212, 214, or 216 (see FIG. 2). The user information field 600 includes an AID12 subfield 602, an RU allocation subfield 604, a coding type subfield 606, a modulation coding scheme (MCS) subfield 608, a dual carrier modulation (DCM) subfield 610, a spatial stream (SS) allocation subfield 612, a target received signal strength indicator (RSSI) subfield 614, a reserved subfield 616, and a trigger dependent user information subfield 618.

At block 3404, the first wireless communication device may determine a basic service set (BSS) color indication associated with the second wireless communication device based at least in part on a high-efficiency (HE) Physical Layer Convergence Procedure (PLCP) protocol data unit (PPDU) format of the trigger frame, the BSS color indication being associated with the second wireless communication device being included in a header of the HE PPDU. The AP may set a rule that it will always send trigger frames that include RUs allocated for random access communications by unassociated STAs in a PPDU formatted according to IEEE 802.11ax or future formats. 11ax PPDUs (e.g., high efficiency (HE) PPDUs) will indicate the BSS color indicator to receiving stations regardless of what frames are included in the PPDU. In this implementation, the AP may determine that it is going to send a trigger frame with an RU allocated for random access communications by unassociated STAs. In response to this determination, the AP may ensure that it does not use a legacy (e.g., pre-11ax) PPDU format to send the trigger frame that includes an RU allocated for random access communications by unassociated STAs.

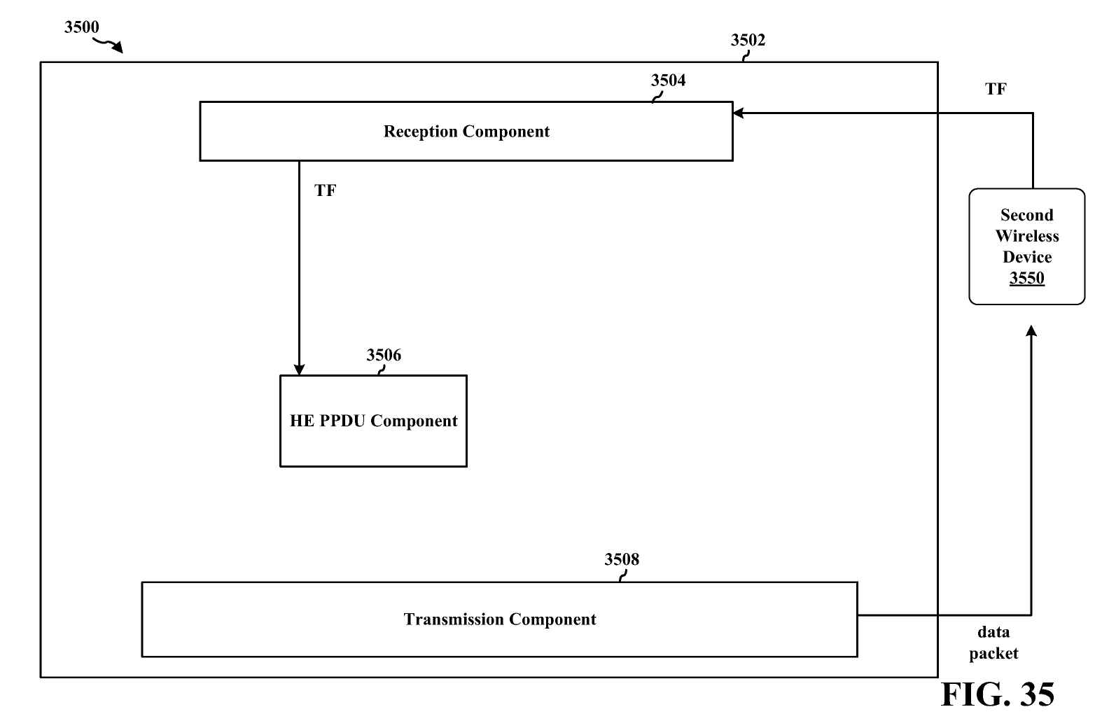

FIG. 35 is a conceptual data flow diagram 3500 illustrating the data flow between different means/components in an exemplary apparatus 3502. The apparatus 3502 may include STA in communication with a second wireless device 3550. The apparatus 3202 may include a reception component 3504, a BSS component 3506, and a transmission component 3508.

The reception component 3504 may be configured to receive a trigger frame, from the second wireless device 3550, that allocates one or more resource units for random access communications by a second wireless communication device. In certain aspects, the first wireless device may be unassociated with the second wireless communication device 3550. The reception component 3504 may send the trigger frame to the BSS determination component 3506.

The BSS determination component 3506 may be configured to determine a basic service set (BSS) color indication associated with the second wireless communication device based at least in part on a high-efficiency (HE) Physical Layer Convergence Procedure (PLCP) protocol data unit (PPDU) format of the trigger frame. In certain aspects, the basic service set (BSS) color indication associated with the second wireless communication device may be included in a header of the HE PPDU.

The transmission component 3508 may be configured to communicate with the second wireless device 3350.

The apparatus may include additional components that perform each of the blocks of the algorithm in the aforementioned flowchart of FIG. 34. As such, each block in the aforementioned flowchart of FIG. 34 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

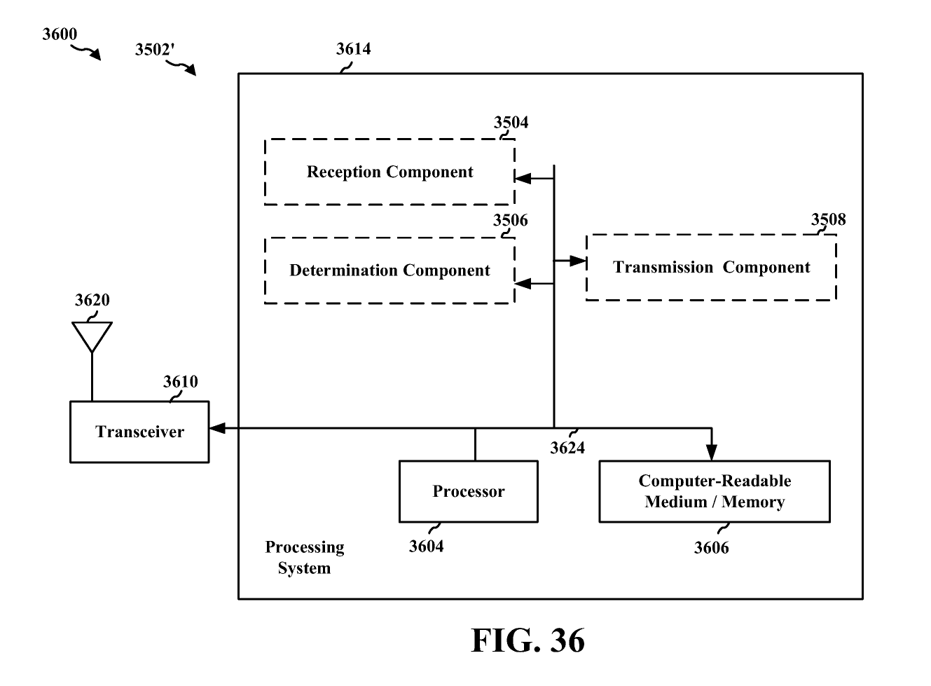

FIG. 36 is a diagram 3600 illustrating an example of a hardware implementation for an apparatus 3502′ employing a processing system 3614. The processing system 3614 may be implemented with a bus architecture, represented generally by the bus 3624. The bus 3624 may include any number of interconnecting buses and bridges depending on the specific application of the processing system 3614 and the overall design constraints. The bus 3624 links together various circuits including one or more processors and/or hardware components, represented by the processor 3604, the components 3504, 3506, 3508, and the computer-readable medium/memory 3606. The bus 3624 may also link various other circuits such as timing sources, peripherals, voltage regulators, and power management circuits, which are well known in the art, and therefore, will not be described any further.

The processing system 3614 may be coupled to a transceiver 3610. The transceiver 3610 is coupled to one or more antennas 3620. The transceiver 3610 provides a means for communicating with various other apparatus over a transmission medium. The transceiver 3610 receives a signal from the one or more antennas 3620, extracts information from the received signal, and provides the extracted information to the processing system 3614, specifically the reception component 3504. In addition, the transceiver 3610 receives information from the processing system 3614, specifically the transmission component 3508, and based on the received information, generates a signal to be applied to the one or more antennas 3620. The processing system 3614 includes a processor 3604 coupled to a computer-readable medium/memory 3606. The processor 3604 is responsible for general processing, including the execution of software stored on the computer-readable medium/memory 3606. The software, when executed by the processor 3604, causes the processing system 3614 to perform the various functions described supra for any particular apparatus. The computer-readable medium/memory 3606 may also be used for storing data that is manipulated by the processor 3604 when executing software. The processing system 3614 further includes at least one of the components 3504, 3506, 3508. The components may be software components running in the processor 3604, resident/stored in the computer readable medium/memory 3606, one or more hardware components coupled to the processor 3604, or some combination thereof.

In certain configurations, the apparatus 3502/3502′ for wireless communication may include means for receiving, at a first wireless communication device, a trigger frame allocates one or more resource units for random access communications by a second wireless communication device. In certain aspects, the first wireless device may be unassociated with the second wireless communication device. In certain configurations, the apparatus 3502/3502′ for wireless communication may include means for determining a basic service set (BSS) color indication associated with the second wireless communication device based at least in part on a high-efficiency (HE) Physical Layer Convergence Procedure (PLCP) protocol data unit (PPDU) format of the trigger frame. In certain aspects, the BSS color indication may be associated with the second wireless communication device being included in a header of the HE PPDU. The aforementioned means may be the processor(s) 202, the radio, the MMU 240, the WLAN controller 250/short-range communications controller 252/the WWAN controller 256, one or more of the aforementioned components of the apparatus 3502 and/or the processing system 3614 of the apparatus 3502′ configured to perform the functions recited by the aforementioned means.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable sub-combination. As such, although features may be described above as acting in particular combinations, and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on. Furthermore, although certain aspects may be described or claimed in the singular, the plural is contemplated unless limitation to the singular is explicitly stated.

What is claimed is:

1. A method for wireless communication, comprising:
determining, at a first wireless communication device, that a trigger frame will allocate one or more resource units for communications by one or more stations unassociated with the first wireless communication device;
adding an indication of a reference channel associated with the first wireless communication device or a basic service set (BSS) color indication to the trigger frame; and
outputting the trigger frame for transmission to one or more other wireless communication devices.

2. The method of claim 1, wherein adding the indication of the reference channel or the BSS color indication comprises adding the indication of the reference channel or the BSS color indication to the trigger frame in response to the determination that the trigger frame will allocate the one or more resource units for communications by the one or more stations unassociated with the first wireless communication device.

3. The method of claim 1, wherein adding the indication of the reference channel or the BSS color indication comprises adding the indication of the reference channel or the BSS color indication to a portion of the trigger frame that has a different meaning to a receiving station when the trigger frame contains a resource unit for communications by an unassociated station than when the trigger frame does not include a resource unit for communications by an unassociated station.

4. The method of claim 1, wherein adding the indication of the reference channel or the BSS color indication comprises adding both the indication of the reference channel and the BSS color indication to the trigger frame.

5. The method of claim 1, wherein adding the indication of the reference channel or the BSS color indication comprises adding the indication of the reference channel to at least one of a portion of a common information field of the trigger frame, a portion of a user information field of the trigger frame, a padding field in the trigger frame, or a scrambler field in a physical layer header of the trigger frame.

6. The method of claim 1, wherein the trigger frame and a broadcast Probe Response frame or the trigger frame and a Fast Initial Link Setup (FILS) discovery frame are output to the one or more other wireless communication devices without aggregation.

7. The method of claim 1, wherein the trigger frame and a broadcast Probe Response frame or the trigger frame and a Fast Initial Link Setup (FILS) discovery frame are output to the one or more other wireless communication devices with aggregation.

8. The method of claim 1, wherein adding the indication of the reference channel or the BSS color indication comprises adding the indication of the reference channel in a padding field of the trigger frame at a location after a first 12 bits of the padding field that are used to indicate a start of the padding field.

9. The method of claim 1, further comprising:
adding an indication, to a spatial stream allocation subfield within the user information field of the trigger frame, of a number of contiguous resource units that are allocated for communications by the one or more stations unassociated with the first wireless communication device.

10. The method of claim 1, wherein adding indication of the reference channel or the BSS color indication comprises adding the BSS color indication to at least a portion of a padding field in the trigger frame, a scrambler field in a physical layer header of the trigger frame, or a trigger dependent user information field of the trigger frame.

11. The method of claim 1, wherein adding the indication of the reference channel or the BSS color indication comprises adding the BSS color indication in a padding field of the trigger frame at a location after a first 12 bits of the padding field that are used to indicate a start of the padding field.

12. The method of claim 1, wherein the one or more resource units of the trigger frame are allocated for random access communications.

13. The method of claim 1, wherein the first wireless communication device is a mobile station, and wherein outputting the trigger frame comprises transmitting the trigger frame through a radio frequency transmitter and an antenna of the mobile station to the one or more other wireless communication devices.

14. The method of claim 1, wherein the first wireless communication device is an access point, and wherein outputting the trigger frame comprises transmitting the trigger frame through a radio frequency transmitter and an antenna of the access point to the one or more other wireless communication devices.

15. A method for wireless communication, comprising:
receiving, at a second wireless communication device, a trigger frame from a first wireless communication device;
determining that the trigger frame allocates one or more resource units for communications by the second wireless communication device that is unassociated with the first wireless communication device; and
identifying a reference channel associated with the first wireless communication device or a basic service set (BSS) color indication from the trigger frame.

16. The method of claim 15, further comprising mapping the one or more resource units allocated in the trigger frame relative to the reference channel.

17. The method of claim 15, further comprising:
determining a location of the one or more resource units by mapping the one or more resource units relative to a location of the reference channel; and
communicating with the first wireless communication device using the one or more resource units allocated for communications by the second wireless communication device that is unassociated with the first wireless communication device.

18. The method of claim 15, wherein identifying the reference channel or the BSS color indication comprises interpreting a portion of the trigger frame to represent the reference channel or the BSS color indication in response to the determination that the trigger frame allocates the one or more resource units for communications by the second wireless communication device that is unassociated with the first wireless communication device.

19. The method of claim 15, wherein identifying the reference channel or the BSS color indication comprises interpreting a portion of the trigger frame differently because the trigger frame allocates a resource unit for communications by an unassociated station than if the trigger frame did not include a resource unit for communications by an unassociated station.

20. The method of claim 15, wherein determining that the trigger frame allocates the one or more resource units for communications comprises determining that a value of an AID12 field of the trigger frame equals 2045.

21. The method of claim 20, wherein the second wireless communication device is a mobile station, and wherein receiving the trigger frame comprises receiving the trigger frame through a radio frequency receiver and an antenna of the mobile station.

22. A method for wireless communication, comprising:
determining, at a first wireless communication device, that a trigger frame will allocate one or more resource units for communications by one or more stations unassociated with the first wireless communication device;
selecting a second frame that includes an indication of a reference channel associated with the first wireless communication device or a basic service set (BSS) color indication associated with the first wireless communication device;
aggregating the trigger frame with the second frame into an aggregated data unit; and
outputting the aggregated data unit for transmission to one or more other wireless communication devices.

23. The method of claim 22, wherein the second frame comprises a management frame.

24. The method of claim 22, wherein the second frame comprises an action frame that includes the indication of the reference channel or the BSS color indication.

25. A method of wireless communication, comprising:
determining, at a first wireless communication device, that a trigger frame will allocate one or more resource units for random access communications by one or more other wireless communication devices unassociated with the first wireless communication device;
selecting a high-efficiency (HE) Physical Layer Convergence Procedure (PLCP) protocol data unit (PPDU) format for the trigger frame upon determining that the trigger frame will allocate one or more resource units for random access communications, a basic service set (BSS) color indication associated with the first wireless communication device being included in a header of the HE PPDU; and
outputting the trigger frame in HE PPDU format for transmission to the one or more other wireless communication devices.

26. A method of wireless communication, comprising:
receiving, at a first wireless communication device, a trigger frame allocates one or more resource units for random access communications by a second wireless communication device, the first wireless device being unassociated with the second wireless communication device; and
determining a basic service set (BSS) color indication associated with the second wireless communication device based at least in part on a high-efficiency (HE) Physical Layer Convergence Procedure (PLCP) protocol data unit (PPDU) format of the trigger frame, the BSS color indication being associated with the second wireless communication device being included in a header of the HE PPDU.
